(19) United States
(12) Patent Application Publication
(10) Pub. No.: US 2023/0364980 A1
(43) Pub. Date: Nov. 16, 2023

(54) Temperature Adjustment System

(71) Applicant: Marelli Corporation, Saitama-city, Saitama (JP)

(72) Inventors: Tatsunari Kawaguchi, Saitama-city, Saitama (JP); Satoshi Ogihara, Saitama-city, Saitama (JP); Tomohiro Maruyama, Saitama-city, Saitama (JP); Toru Kawamata, Saitama-city, Saitama (JP); Takashi Nakamura, Saitama-city, Saitama (JP); Yuuki Tani, Saitama-city, Saitama (JP); Kouji Hirono, Saitama-city, Saitama (JP); Satoshi Shimizu, Saitama-city, Saitama (JP); Tomohiro Maeda, Saitama-city, Saitama (JP); Shigeyoshi Kadokura, Saitama-city, Saitama (JP)

(21) Appl. No.: 18/030,450

(22) PCT Filed: Oct. 8, 2021
(86) PCT No.: PCT/JP2021/037445

§ 371 Date: Apr. 5, 2023

(30) Foreign Application Priority Data
Oct. 8, 2020 (JP) 2020-170649

(51) Int. Cl. B60K 11/02; B60H 1/32; B60L 58/26

(52) U.S. Cl. CPC B60K 11/02; B60H 1/3228; B60H 1/3227; B60L 58/26

(57) ABSTRACT

A temperature adjustment system includes: a refrigeration cycle circuit including a first compressor, a heat radiator, a first expansion valve, a chiller configured to perform heat exchange using the expanded refrigerant, and a gas-liquid separator configured to perform gas-liquid separation on the refrigerant and supply a gas phase refrigerant to the first compressor; a first cooling water circuit including an external heat radiator; a second cooling water circuit configured to heat the cooling water flowing therethrough by the heat of the refrigerant radiated by the heat radiator; a third cooling water circuit configured to cool the cooling water flowing therethrough, and adjust a temperature of a device by heat exchange with the cooling water; a first valve configured to connect or disconnect the first and the second cooling water circuits; and a second valve configured to connect or disconnect the second and the third cooling water circuits.

### TECHNICAL FIELD

The present invention relates to a temperature adjustment system that adjusts a temperature of a device to be subjected to temperature adjustment.

### BACKGROUND ART

JP6206231B discloses a vehicle thermal management system that includes a low-temperature-side cooling water circuit provided with a cooling water cooler and for supplying low-temperature cooling water, a high-temperature-side cooling water circuit provided with a cooling water heater and for supplying high-temperature cooling water, a heat exchanger for battery temperature adjustment for performing heat exchange between the cooling water supplied from the low-temperature-side cooling water circuit or the high-temperature-side cooling water circuit and a battery, and a first switching valve and a second switching valve for switching between the cooling water circuits (the low-temperature-side cooling water circuit or the high-temperature-side cooling water circuit) connected to the heat exchanger for battery temperature adjustment.

In the vehicle thermal management system described above, the battery is cooled or warmed up by switching the cooling water circuit for supplying the cooling water to the heat exchanger for battery temperature adjustment according to a state of charge and a temperature state of the battery.

### SUMMARY OF INVENTION

However, in the vehicle thermal management system in JP6206231B, since configurations of the first switching valve and the second switching valve for switching between the connections to the two cooling water circuits are complicated, the entire system is complicated.

An object of the present invention is to provide a temperature adjustment system capable of adjusting a temperature of a device to be subjected to temperature adjustment with a simple configuration.

According to an aspect of the present invention, a temperature adjustment system configured to adjust a temperature of a device to be subjected to temperature adjustment, the temperature adjustment system includes: a refrigeration cycle circuit including a first compressor configured to compress a refrigerant, a heat radiator configured to radiate heat of the refrigerant compressed by the first compressor, a first expansion valve configured to expand the refrigerant from which the heat is radiated by the heat radiator, a chiller configured to perform heat exchange using the refrigerant expanded by the first expansion valve, and a gas-liquid separator configured to perform gas-liquid separation on the refrigerant used for the heat exchange in the chiller and supply a gas phase refrigerant to the first compressor; a first cooling water circuit including an external heat radiator for radiating heat of cooling water to an outside; a second cooling water circuit configured to heat the cooling water flowing therethrough by the heat of the refrigerant radiated by the heat radiator; a third cooling water circuit configured to cool the cooling water flowing therethrough by the heat exchange with the refrigerant flowing through the chiller, and adjust the temperature of the device to be subjected to temperature adjustment by heat exchange with the cooling water; a first valve configured to connect or disconnect the first cooling water circuit and the second cooling water circuit; and a second valve configured to connect or disconnect the second cooling water circuit and the third cooling water circuit.

In the above aspect, the first valve and the second valve connect or disconnect the first cooling water circuit that radiates heat of cooling water, the second cooling water circuit that heats the cooling water by the refrigeration cycle circuit, and the third cooling water circuit that cools the cooling water by the refrigeration cycle circuit. Accordingly, the temperature of the device to be subjected to temperature adjustment can be adjusted by adjusting a temperature of the cooling water that exchanges heat with the device to be subjected to temperature adjustment. The first valve and the second valve each have a simple configuration that only switches between connection or disconnection of the cooling water circuits. Therefore, it is possible to provide a temperature adjustment system capable of adjusting a temperature of a device to be subjected to temperature adjustment with a simple configuration.

### BRIEF DESCRIPTION OF DRAWINGS

FIG. 1 is a configuration diagram of a temperature adjustment system according to an embodiment of the present invention.

FIG. 2 is a diagram illustrating a heating mode of an air conditioner.

FIG. 3 is a diagram illustrating a cooling mode of the air conditioner.

FIG. 4 is a diagram illustrating a first cooling mode of the temperature adjustment system.

FIG. 5 is a diagram illustrating a heating mode of the temperature adjustment system.

FIG. 6 is a diagram illustrating a second cooling mode of the temperature adjustment system.

FIG. 7 is a diagram illustrating an auxiliary heating mode of the temperature adjustment system.

FIG. 8 is a schematic configuration diagram of a gas-liquid separator provided in the temperature adjustment system.

FIG. 9A is a schematic configuration diagram of a gas-liquid separator according to a first modification.

FIG. 9B is a schematic configuration diagram of the gas-liquid separator according to the first modification in a mode different from that in FIG. 9A.

FIG. 10A is a schematic configuration diagram of a gas-liquid separator according to a second modification.

FIG. 10B is a schematic configuration diagram of the gas-liquid separator according to the second modification in a mode different from that in FIG. 10A.

FIG. 11A is a schematic configuration diagram of a gas-liquid separator according to a third modification.

FIG. 11B is a schematic configuration diagram of the gas-liquid separator according to the third modification in a mode different from that in FIG. 11A.

FIG. 12A is a schematic configuration diagram of a gas-liquid separator according to a fourth modification.

FIG. 12B is a schematic configuration diagram of the gas-liquid separator according to the fourth modification in a mode different from that in FIG. 12A.

FIG. 13A is a schematic configuration diagram of a gas-liquid separator according to a fifth modification.

FIG. 13B is a schematic configuration diagram of the gas-liquid separator according to the fifth modification in a mode different from that in FIG. 13A.

### DESCRIPTION OF EMBODIMENTS

Hereinafter, a temperature adjustment system 1 according to an embodiment of the present invention will be described with reference to the drawings.

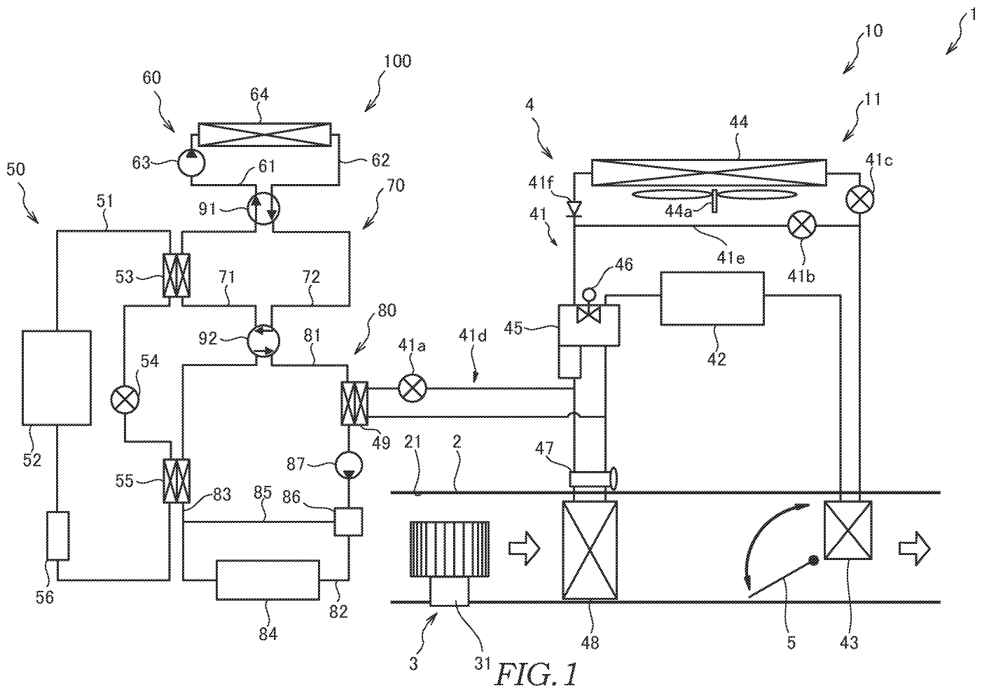

First, a configuration of the temperature adjustment system 1 will be described with reference to FIG. 1.

The temperature adjustment system 1 is a system that is mounted on a vehicle (not shown), and includes an air conditioner 10 that performs air conditioning in a vehicle interior (not shown), and a temperature adjustment circuit 100 that adjusts a temperature of a battery 84 serving as a device to be subjected to temperature adjustment mounted on the vehicle. In the present embodiment, a case where the device to be subjected to temperature adjustment is the battery 84 will be described, and the device to be subjected to temperature adjustment is not particularly limited as long as it is a device requiring temperature adjustment. Other examples of the device to be subjected to temperature adjustment include an electric power train, an engine oil, and a transmission oil in a vehicle.

The air conditioner 10 includes an air passage 2 having an air introduction port 21, a blower unit 3 for introducing air from the air introduction port 21 and flowing the air into the air passage 2, a heat pump unit 4 serving as an air-conditioning refrigeration cycle circuit for cooling or heating the air flowing through the air passage 2, and an air mix door 5 for adjusting the air in contact with a heater core 43 of the heat pump unit 4, which will be described later.

The air sucked through the air introduction port 21 flows through the air passage 2. Outside air outside the vehicle interior and inside air inside the vehicle interior are sucked into the air passage 2. The air that has passed through the air passage 2 is guided into the vehicle interior.

The blower unit 3 includes a blower 31 serving as an air blowing device that flows air through the air passage 2 by rotation around a shaft. The blower unit 3 includes an intake door (not shown) for opening and closing an outside air inlet for taking in the outside air outside the vehicle interior and an inside air inlet for taking in the inside air inside the vehicle interior. The intake door can adjust the opening and closing or opening degrees of the outside air inlet and the inside air inlet, and can adjust suction amounts of the outside air outside the vehicle interior and the inside air inside the vehicle interior.

The heat pump unit 4 includes a refrigerant circulation circuit 41 through which an air-conditioning refrigerant circulates, an electric compressor 42 serving as a second compressor that is driven by an electric motor (not shown) to compress the air-conditioning refrigerant, the heater core 43 that heats the air by heat of the refrigerant compressed by the electric compressor 42, an outdoor heat exchanger 44 that performs heat exchange between the air-conditioning refrigerant flowing in via the heater core 43 and the outside air, a gas-liquid separator 45 that separates the refrigerant flowing in from the heater core 43 or the outdoor heat exchanger 44 into a liquid phase refrigerant and a gas phase refrigerant, a switching valve 46 that switches the flow of the refrigerant from the gas-liquid separator 45, a thermal expansion valve 47 that decompresses and expands the liquid phase refrigerant flowing in from the gas-liquid separator 45 to lower a temperature thereof, and an evaporator 48 that cools the air in the air passage 2 by the refrigerant expanded by the thermal expansion valve 47 and having a lowered temperature. The heat pump unit 4 further includes a heat exchanger 49 that performs heat exchange using the liquid phase refrigerant flowing in from the gas-liquid separator 45.

The refrigerant circulation circuit 41 is constituted by a flow passage connecting the components of the heat pump unit 4, and the air-conditioning refrigerant flows therein. The refrigerant circulation circuit 41 is provided with variable throttle mechanisms 41a to 41c whose opening degrees are adjusted according to a command signal from a controller (not shown). Specifically, in the refrigerant circulation circuit 41, the variable throttle mechanism 41a is provided in a bypass flow passage 41d that bypasses the evaporator 48. The variable throttle mechanism 41a corresponds to a second expansion valve. In the refrigerant circulation circuit 41, the variable throttle mechanism 41b is provided in a bypass flow passage 41e that bypasses the outdoor heat exchanger 44. In the refrigerant circulation circuit 41, the variable throttle mechanism 41c is provided in a flow passage between the bypass flow passage 41e and the outdoor heat exchanger 44. The variable throttle mechanisms 41a to 41c allow passage of the air-conditioning refrigerant in an on state, block the passage of the air-conditioning refrigerant in an off state, and decompress and expand the air-conditioning refrigerant in a throttled state. A throttle degree in the throttled state is appropriately adjusted by the controller.

The electric compressor 42 is, for example, a vane-type rotary compressor, or may be a scroll-type compressor. A rotation speed of the electric compressor 42 is controlled by a command signal from the controller.

The heater core 43 is provided in the air passage 2. The air-conditioning refrigerant compressed by the electric compressor 42 flows into the heater core 43. When the air flowing through the air passage 2 is in contact with the heater core 43, the heater core 43 performs heat exchange between the air and the air-conditioning refrigerant compressed by the electric compressor 42 to warm the air. An amount of the air in contact with the heater core 43 is adjusted according to a position of the air mix door 5 provided on an upstream side in an air flow direction in the air passage 2 with respect to the heater core 43. The position of the air mix door 5 moves according to a command signal from the controller.

The outdoor heat exchanger 44 is disposed in, for example, an engine room of the vehicle (a motor room of an electric vehicle), and performs the heat exchange between the air-conditioning refrigerant flowing in via the heater core 43 and the outside air. The outside air is introduced into the outdoor heat exchanger 44 by traveling of the vehicle and rotation of an outdoor fan 44a. A check valve 41f is provided downstream of the outdoor heat exchanger 44 of the heat pump unit 4 (specifically, between the outdoor heat exchanger 44 and the gas-liquid separator 45).

The gas-liquid separator 45 separates the air-conditioning refrigerant flowing in from the outdoor heat exchanger 44 into an air-conditioning refrigerant in a liquid phase and an air-conditioning refrigerant in a gas phase.

The switching valve 46 is an electromagnetic valve having a solenoid to be controlled by the controller. When the switching valve 46 is switched to the open state, the air-conditioning refrigerant in the gas phase is guided to the electric compressor 42. On the other hand, when the switching valve 46 is switched to the close state, the air-conditioning refrigerant in the liquid phase is guided from the gas-liquid separator 45 to the variable throttle mechanism 41a or the thermal expansion valve 47.

When the air-conditioning refrigerant in the liquid phase flows in from the gas-liquid separator 45, the thermal expansion valve 47 decompresses and expands the air-conditioning refrigerant in the liquid phase to lower the temperature thereof. The thermal expansion valve 47 has a temperature sensitive tubular portion attached to an outlet side of the evaporator 48, and an opening degree thereof is automatically adjusted to maintain a heating degree of the refrigerant on the outlet side of the evaporator 48 to a predetermined value.

The evaporator 48 is provided in the air passage 2, and cools and dehumidifies the air flowing through the air passage 2 by performing heat exchange between the air-conditioning refrigerant in the liquid phase decompressed by the thermal expansion valve 47 and the air flowing through the air passage 2. In the evaporator 48, the air-conditioning refrigerant in the liquid phase is evaporated by the heat of the air flowing through the air passage 2, and becomes the air-conditioning refrigerant in the gas phase. The air-conditioning refrigerant in the gas phase is supplied to the electric compressor 42 again via the gas-liquid separator 45.

The heat exchanger 49 is provided downstream of the variable throttle mechanism 41a in the bypass flow passage 41d. The air-conditioning refrigerant flows into the heat exchanger 49 via the variable throttle mechanism 41a, and cooling water flows into the heat exchanger 49 via a third cooling water circuit 80 of the temperature adjustment circuit 100 to be described later. That is, the heat exchanger 49 performs heat exchange between the air-conditioning refrigerant flowing in via the variable throttle mechanism 41a and the cooling water flowing through the third cooling water circuit 80.

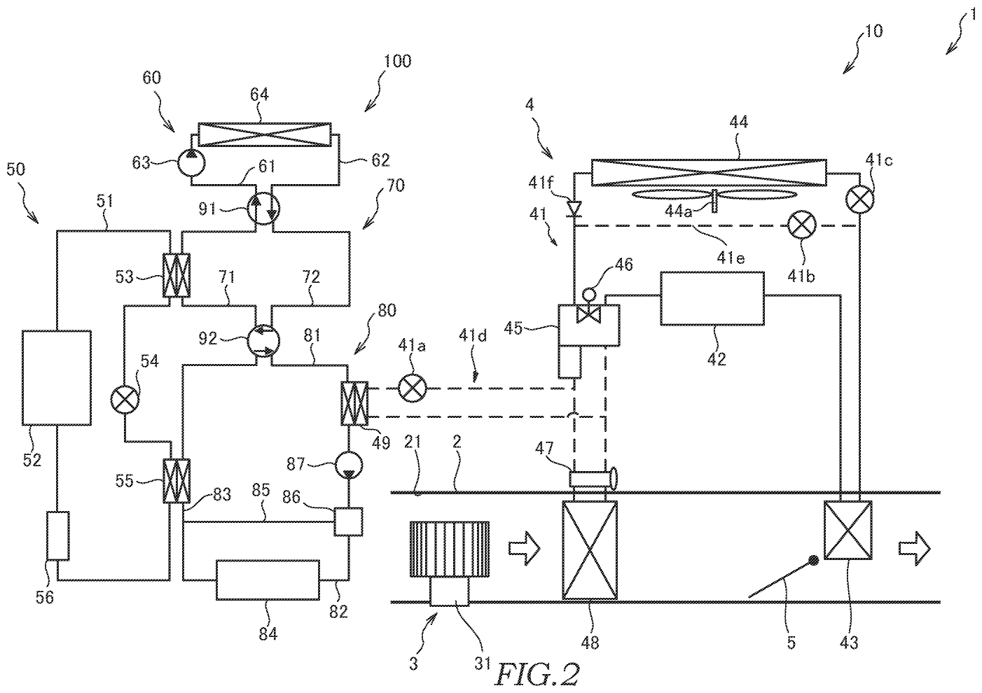

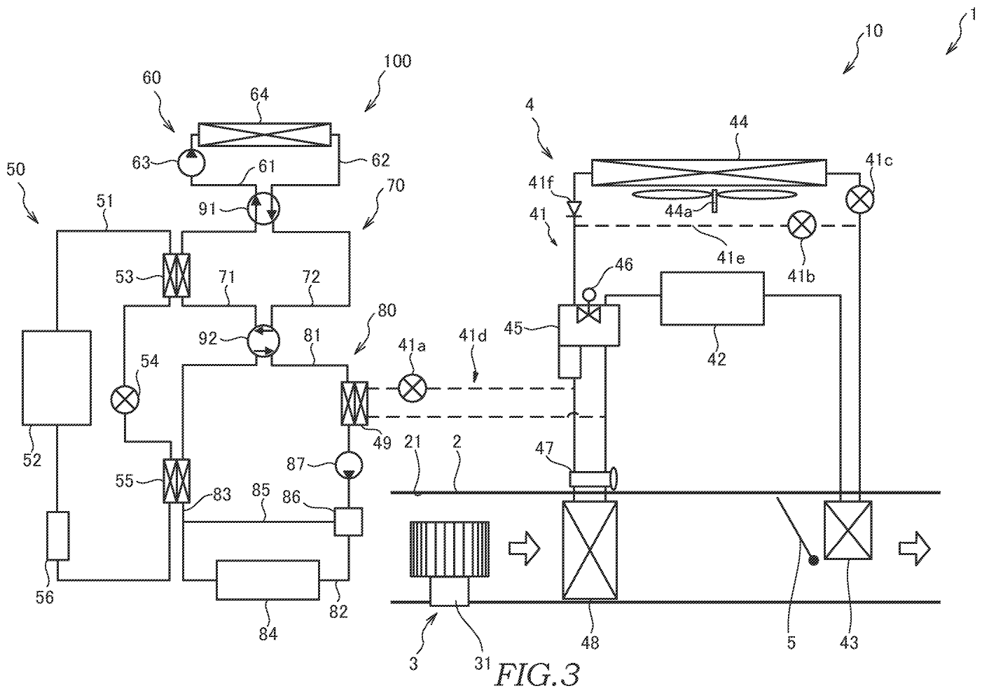

Next, operation modes of the air conditioner 10 will be described with reference to FIGS. 2 and 3. In FIGS. 2 and 3, a portion where the air-conditioning refrigerant flows through is indicated by a solid line, and a portion where the air-conditioning refrigerant stops flowing through is indicated by a broken line.

<Heating Mode>

FIG. 2 is a diagram illustrating a heating mode of the air conditioner 10. The heating mode is a mode in which the air conditioner 10 operates in a situation where the vehicle interior is heated.

In the heating mode, the air mix door 5 is adjusted to a position where the air flowing through the air passage 2 is guided to the heater core 43. The variable throttle mechanism 41a is set to the close state for blocking the bypass flow passage 41d (blocking the connection between the gas-liquid separator 45 and the heat exchanger 49). The variable throttle mechanism 41b is set to the close state for blocking the bypass flow passage 41e (blocking the connection between the heater core 43 and the gas-liquid separator 45). The variable throttle mechanism 41c is set to the throttled state for decompressing and expanding the air-conditioning refrigerant guided from the heater core 43 to the outdoor heat exchanger 44. The switching valve 46 is switched to the open state such that the air-conditioning refrigerant in the gas phase guided from the outdoor heat exchanger 44 flows into the electric compressor 42, and the air-conditioning refrigerant in the liquid phase does not flow from the gas-liquid separator 45 into the thermal expansion valve 47 and the evaporator 48.

Accordingly, the air-conditioning refrigerant compressed by the electric compressor 42 and flowing into the heater core 43 is subject to heat exchange with the air passing through the heater core 43 and is liquefied. That is, in the heating mode, the heater core 43 functions as a condenser. Further, the air that has passed through the heater core 43 and has heated is guided from the air passage 2 into the vehicle interior. Accordingly, the vehicle interior is heated.

The air-conditioning refrigerant liquefied by the heater core 43 passes through the variable throttle mechanism 41c and is decompressed and expanded, and flows into the outdoor heat exchanger 44. The air-conditioning refrigerant that has flowed into the outdoor heat exchanger 44 is subjected to heat exchange with the outside air introduced into the outdoor heat exchanger 44 and is vaporized. That is, in the heating mode, the outdoor heat exchanger 44 functions as an evaporator.

The air-conditioning refrigerant vaporized by the outdoor heat exchanger 44 is supplied to the electric compressor 42 again via the check valve 41f, the gas-liquid separator 45, and the switching valve 46. In the heating mode, when the air-conditioning refrigerant circulates in the heat pump unit 4 as described above, the air flowing through the air passage 2 is heated and the vehicle interior is heated.

<Cooling Mode>

FIG. 3 is a diagram illustrating a cooling mode of the air conditioner 10. The cooling mode is a mode in which the air conditioner 10 operates in a situation where the vehicle interior is cooled.

In the cooling mode, the air mix door 5 is adjusted to a position where the air flowing through the air passage 2 bypasses the heater core 43. The variable throttle mechanism 41a is set to the close state for blocking the bypass flow passage 41d (blocking the connection between the gas-liquid separator 45 and the heat exchanger 49). The variable throttle mechanism 41b is set to the close state for blocking the bypass flow passage 41e (blocking the connection between the heater core 43 and the gas-liquid separator 45). The variable throttle mechanism 41c is set to the open state in which the air-conditioning refrigerant can flow from the heater core 43 to the outdoor heat exchanger 44. The switching valve 46 is switched to the close state such that the air-conditioning refrigerant in the liquid phase flows from the gas-liquid separator 45 into the thermal expansion valve 47, and the air-conditioning refrigerant in the gas phase guided from the outdoor heat exchanger 44 does not flow into the electric compressor 42.

Accordingly, the air-conditioning refrigerant compressed by the electric compressor 42 flows into the outdoor heat exchanger 44 via the heater core 43 and the variable throttle mechanism 41c while keeping a high-temperature and high-pressure state. The air-conditioning refrigerant is subjected to heat exchange with the air passing through the outdoor heat exchanger 44 and is liquefied. That is, in the cooling mode, the outdoor heat exchanger 44 functions as a condenser.

The air-conditioning refrigerant liquefied by the outdoor heat exchanger 44 flows into the gas-liquid separator 45, and is separated into the air-conditioning refrigerant in the gas phase and the air-conditioning refrigerant in the liquid phase. The air-conditioning refrigerant in the liquid phase stored in the gas-liquid separator 45 flows into the evaporator 48 via the thermal expansion valve 47.

The thermal expansion valve 47 decompresses and expands the liquid phase refrigerant flowing in from the gas-liquid separator 45. The thermal expansion valve 47 feeds back a temperature of the gas phase refrigerant that has passed through the evaporator 48, and an opening degree thereof is adjusted such that the gas phase refrigerant has an appropriate heating degree.

The air-conditioning refrigerant that has flowed into the evaporator 48 is subjected to heat exchange with the air flowing through the air passage 2, and is vaporized by the heat of the air flowing through the air passage 2. That is, in the cooling mode, the evaporator 48 functions as an evaporator. The air in the air passage 2 subjected to the heat exchange with the air-conditioning refrigerant that has flowed into the evaporator 48 is cooled and dehumidified, and passes through the air passage 2. Accordingly, the vehicle interior is cooled or dehumidified.

The air-conditioning refrigerant vaporized by the evaporator 48 is supplied to the electric compressor 42 again via the gas-liquid separator 45. In the cooling mode, when the air-conditioning refrigerant circulates in the heat pump unit 4 as described above, the air flowing through the air passage 2 is cooled and dehumidified.

Next, the configuration of the temperature adjustment circuit 100 will be mainly described with reference to FIG. 1.

As illustrated in FIG. 1, the temperature adjustment circuit 100 includes a refrigeration cycle circuit 50, a first cooling water circuit 60, a second cooling water circuit 70, and the third cooling water circuit 80 through which the cooling water for adjusting the temperature of the battery 84 flows, a switching valve 91 serving as a first valve that connects or disconnects the first cooling water circuit 60 and the second cooling water circuit 70, and a switching valve 92 serving as a second valve that connects or disconnects the second cooling water circuit 70 and the third cooling water circuit 80.

The refrigeration cycle circuit 50 includes a refrigerant circulation circuit 51 through which the refrigerant circulates, an electric compressor 52 serving as a first compressor that is driven by the electric motor (not shown) to compress the refrigerant, a water-cooled condenser 53 serving as a heat radiator that radiates the heat of the refrigerant compressed by the electric compressor 52, a variable throttle mechanism 54 serving as a first expansion valve that expands the refrigerant from which the heat is radiated by the water-cooled condenser 53, a chiller 55 that performs heat exchange by using the refrigerant expanded by the variable throttle mechanism 54, and a gas-liquid separator 56 that performs gas-liquid separation on the refrigerant used for heat exchange by the chiller 55 and supplies the gas phase refrigerant to the electric compressor 52.

The electric compressor 52 is, for example, a vane-type rotary compressor, or may be a scroll-type compressor. A rotation speed of the electric compressor 52 is controlled by a command signal from the controller.

The water-cooled condenser 53 performs heat exchange between the refrigerant compressed by the electric compressor 52 and the cooling water flowing in from the second cooling water circuit 70 (a cooling water flow passage 71). Specifically, the water-cooled condenser 53 radiates the heat of the refrigerant compressed by the electric compressor 52 to heat the cooling water flowing through the second cooling water circuit 70.

An opening degree of the variable throttle mechanism 54 is adjusted according to control by the controller. The variable throttle mechanism 54 decompresses and expands the refrigerant flowing in from the water-cooled condenser 53 according to the opening degree.

The chiller 55 performs heat exchange between the refrigerant expanded by the variable throttle mechanism 54 and the cooling water flowing through the third cooling water circuit 80. Specifically, in the chiller 55, the refrigerant expanded by the variable throttle mechanism 54 is evaporated, and thereby the cooling water flowing through the third cooling water circuit 80 is cooled.

The gas-liquid separator 56 separates the refrigerant used for the heat exchange by the chiller 55 into a gas phase refrigerant and a liquid phase refrigerant, and supplies the gas phase refrigerant to the electric compressor 52. In addition, the gas-liquid separator 56 supplies the liquid phase refrigerant to the electric compressor 52 together with the gas phase refrigerant according to the operation mode of the temperature adjustment system 1. The configuration of the gas-liquid separator 56 and the details of the supply of the refrigerant will be described later.

The first cooling water circuit 60 includes cooling water flow passages 61 and 62 in which the cooling water flows, a pump 63 that sends out the cooling water, and an external heat radiator 64 that radiates the heat of the cooling water to the outside.

The second cooling water circuit 70 includes the cooling water flow passage 71 and a cooling water flow passage 72 in which the cooling water flows. The cooling water flow passage 71 communicates with the water-cooled condenser 53. Therefore, the cooling water flowing in the cooling water flow passage 71 flows into the water-cooled condenser 53 and is heated by the heat of the refrigerant in the refrigeration cycle circuit 50.

The third cooling water circuit 80 includes cooling water flow passages 81 to 83 in which the cooling water flows, a bypass flow passage 85 through which the cooling water flows to bypass the battery 84, a switching valve 86 serving as a third valve, and a pump 87 that sends out the cooling water.

The cooling water flow passage 81 communicates with the heat exchanger 49. When an air-conditioning refrigerant flows through the heat exchanger 49, the cooling water flowing through the cooling water flow passage 81 is subjected to heat exchange with the air-conditioning refrigerant.

The cooling water flow passage 82 is provided with the battery 84 that is to be subjected to heat exchange with the cooling water flowing through the cooling water flow passage 82. When the cooling water flows in the cooling water flow passage 82, the heat exchange is performed between the cooling water and the battery 84.

The cooling water flow passage 83 communicates with the chiller 55. The cooling water flowing through the cooling water flow passage 83 is subjected to heat exchange with the refrigerant flowing through the chiller 55 and is cooled.

The bypass flow passage 85 is a flow passage that connects the cooling water flow passage 81 and the cooling water flow passage 83, and is a flow passage through which the cooling water flows to bypass the battery 84.

The switching valve 91 is provided between the first cooling water circuit 60 and the second cooling water circuit 70. The switching valve 91 is a four-way valve for switching in response to a command signal from the controller.

When the switching valve 91 is switched to a connection state, the switching valve 91 connects the cooling water flow passage 61 and the cooling water flow passage 71, and connects the cooling water flow passage 62 and the cooling water flow passage 72 (see FIG. 1). That is, the switching valve 91 in the connection state connects the first cooling water circuit 60 and the second cooling water circuit 70.

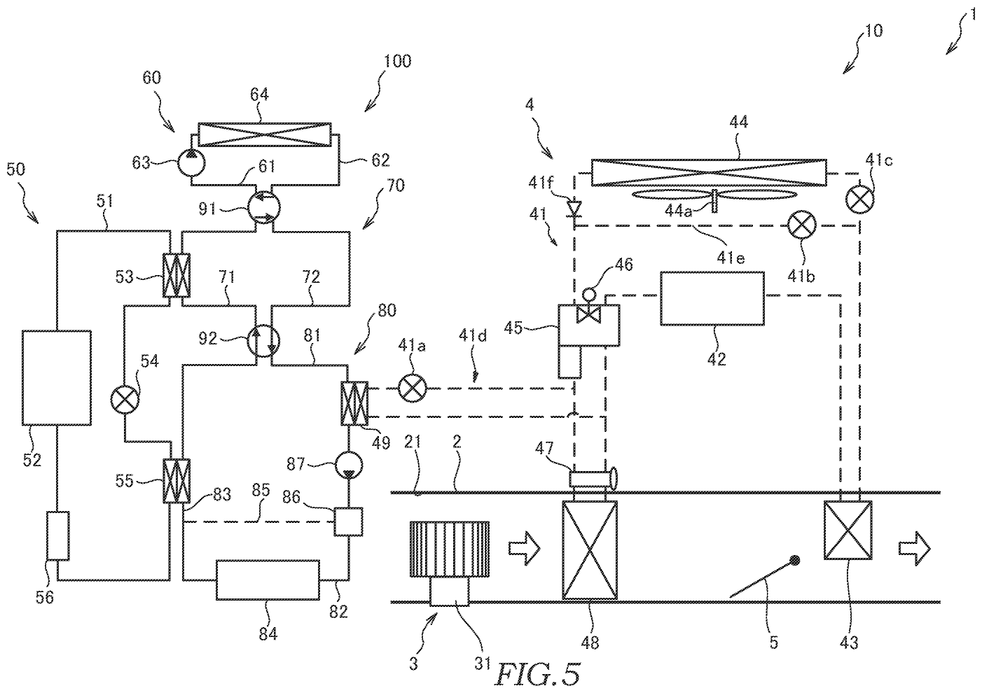

When the switching valve 91 is switched to a disconnection state, the switching valve 91 connects the cooling water flow passage 61 and the cooling water flow passage 62, and connects the cooling water flow passage 71 and the cooling water flow passage 72 (see FIG. 5). That is, the switching valve 91 in the disconnection state disconnects the first cooling water circuit 60 and the second cooling water circuit 70.

In this way, the switching valve 91 has a simple configuration that only switches to connect or disconnect the first cooling water circuit 60 and the second cooling water circuit 70.

The switching valve 92 is provided between the second cooling water circuit 70 and the third cooling water circuit 80. The switching valve 92 is a four-way valve for switching in response to a command signal from the controller.

When the switching valve 92 is switched to a connection state, the switching valve 92 connects the cooling water flow passage 71 and the cooling water flow passage 83, and connects the cooling water flow passage 72 and the cooling water flow passage 81 (see FIG. 5). That is, the switching valve 92 in the connection state connects the first cooling water circuit 60 and the second cooling water circuit 70.

When the switching valve 92 is switched to a disconnection state, the switching valve 92 connects the cooling water flow passage 71 and the cooling water flow passage 72, and connects the cooling water flow passage 81 and the cooling water flow passage 83 (see FIG. 1). That is, the switching valve 92 in the disconnection state disconnects the second cooling water circuit 70 and the third cooling water circuit 80.

In this way, the switching valve 92 has a simple configuration that only switches to connect or disconnect the second cooling water circuit 70 and the third cooling water circuit 80.

The switching valve 86 is a three-way valve for switching in response to a command signal from the controller. The switching valve 86 switches to allow the cooling water flowing in from the cooling water flow passage 81 to flow through the cooling water flow passage 82, or to flow through the bypass flow passage 85.

When the switching valve 86 is switched to connect the cooling water flow passage 81 and the cooling water flow passage 82 and block the cooling water flow passage 81 and the bypass flow passage 85, the cooling water flows from the cooling water flow passage 81 into the cooling water flow passage 82 and is subjected to the heat exchange with the battery 84. At this time, the switching valve 86 allows the cooling water to flow through the cooling water flow passage 82 so as to be subjected to the heat exchange with the battery 84 without allowing the cooling water to flow through the bypass flow passage 85.

When the switching valve 86 is switched to connect the cooling water flow passage 81 and the bypass flow passage 85 and block the cooling water flow passage 81 and the bypass flow passage 85, the cooling water flows from the cooling water flow passage 81 into the bypass flow passage 85. At this time, the switching valve 86 allows the cooling water to flow through the bypass flow passage 85 without allowing the cooling water to flow through the cooling water flow passage 82.

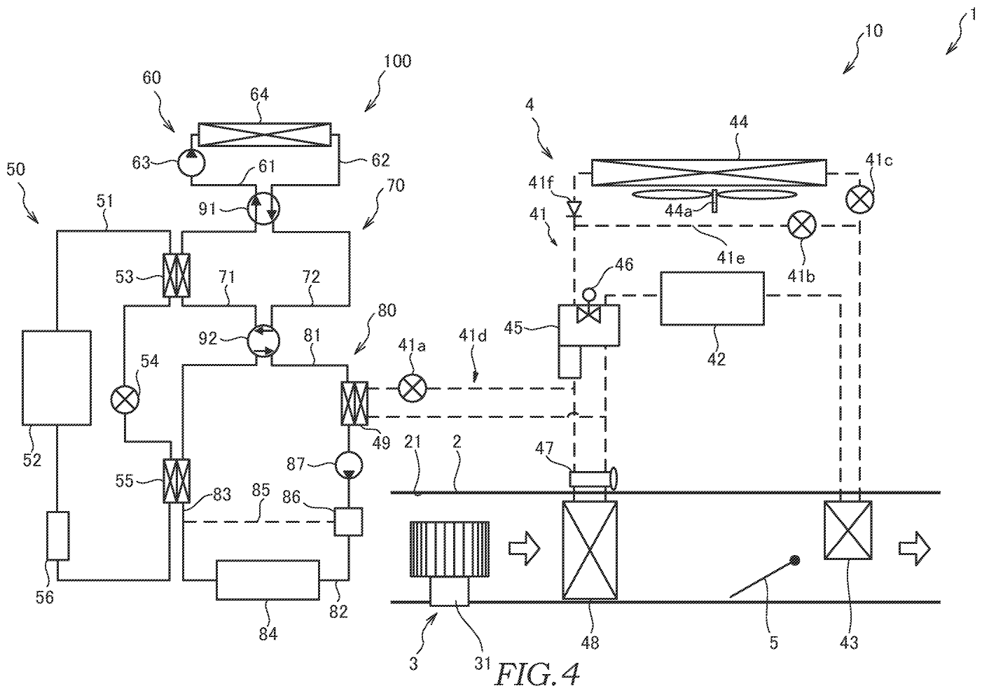

Next, effects in the operation modes of the temperature adjustment system 1 having the above configuration will be described with reference to FIGS. 4 to 7. In FIGS. 4 to 7, portions where heat transfer media (the refrigerant, the air-conditioning refrigerant, and the cooling water) flow through during the operation modes corresponding to the respective figures are indicated by solid lines, and portions where the heat transfer media stop flowing through are indicated by broken lines.

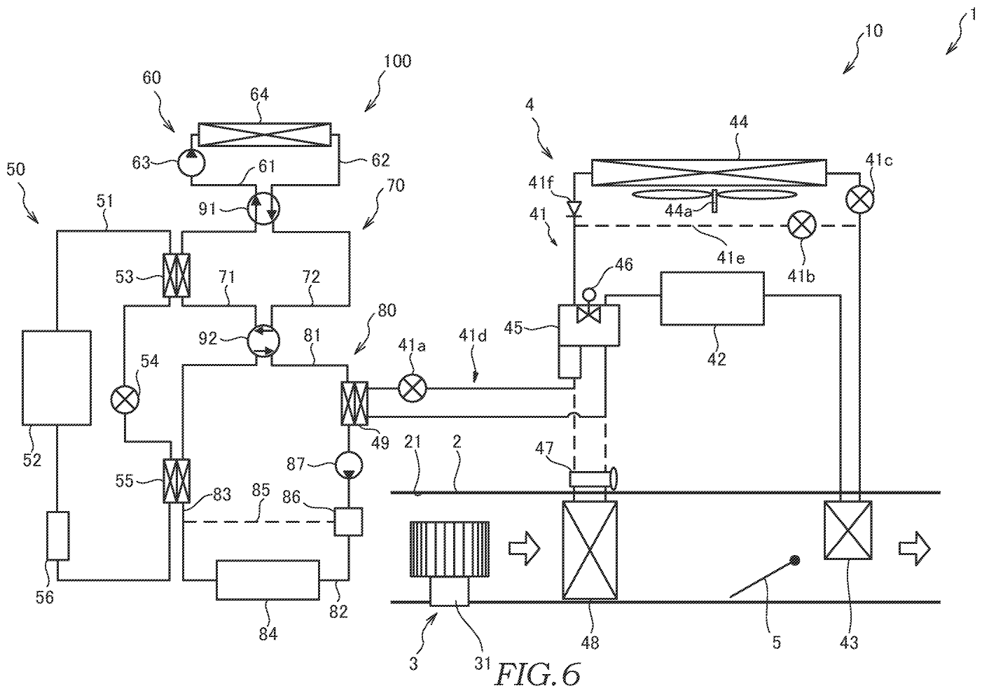

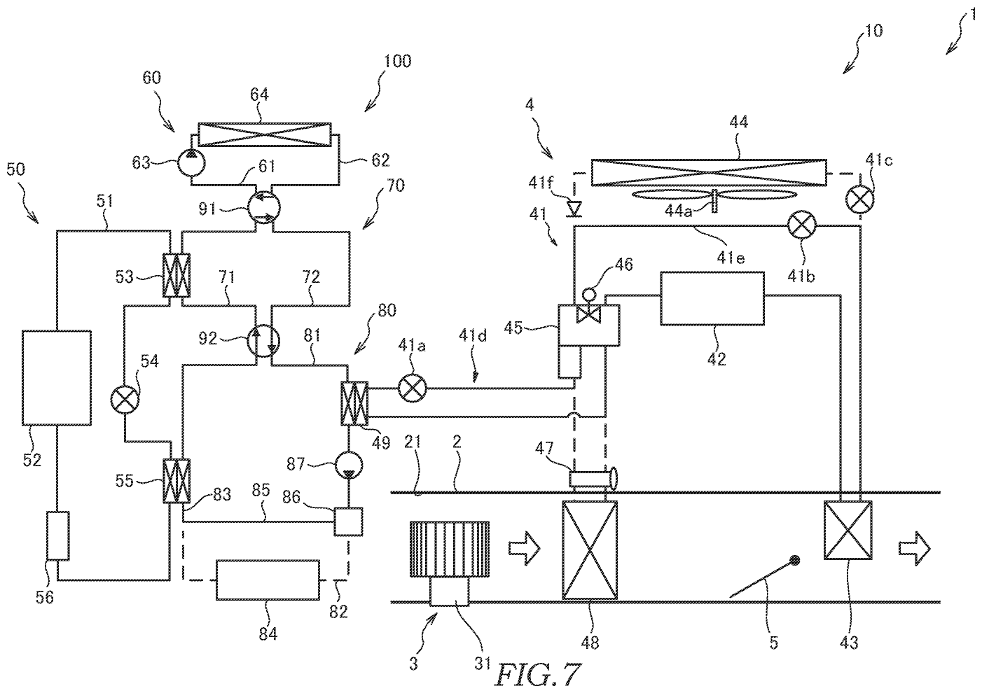

The temperature adjustment system 1 operates by being switched in four modes according to a state of the vehicle and the device to be subjected to temperature adjustment. The four modes include a first cooling mode in which the battery 84 is cooled (see FIG. 4), a heating mode in which the battery 84 is heated (see FIG. 5), a second cooling mode in which the battery 84 is strongly cooled as compared with the first cooling mode (see FIG. 6), and an auxiliary heating mode in which the vehicle interior is heated by cooperating the heat pump unit 4 with the temperature adjustment circuit 100 (see FIG. 7).

<First Cooling Mode>

FIG. 4 is a diagram illustrating the first cooling mode of the temperature adjustment system 1. The first cooling mode is a mode in which the temperature adjustment system 1 operates in a situation where it is necessary to cool the battery 84 due to heat generation of the battery 84 or the like.

In the first cooling mode, the switching valve 91 is switched to the connection state, and the switching valve 92 is switched to the disconnection state. That is, the switching valve 91 connects the first cooling water circuit 60 and the second cooling water circuit 70, and the switching valve 92 disconnects the second cooling water circuit 70 and the third cooling water circuit 80. Further, the switching valve 86 is switched to connect the cooling water flow passage 81 and the cooling water flow passage 82, and block the cooling water flow passage 81 and the bypass flow passage 85.

Further, in the first cooling mode, the variable throttle mechanism 41a is set to the close state for blocking the bypass flow passage 41d (blocking the connection between the gas-liquid separator 45 and the heat exchanger 49). That is, the air-conditioning refrigerant does not flow into the heat exchanger 49, and thus in the first cooling mode, the heat exchange is not performed between the air-conditioning refrigerant and the cooling water flowing through the third cooling water circuit 80. The states of the variable throttle mechanisms 41b and 41c in the first cooling mode and the arrangement of the air mix door 5 are not particularly limited, and are optional. That is, the temperature adjustment system 1 is switched to the first cooling mode by only switching the switching valve 91, the switching valve 92, the switching valve 86, and the variable throttle mechanism 41a.

In the first cooling mode, the heat exchange between the refrigerant compressed by the electric compressor 52 and the cooling water flowing through the cooling water flow passage 71 is performed in the water-cooled condenser 53. Accordingly, the refrigerant is liquefied, and the cooling water flowing through the cooling water flow passage 71 is heated.

The cooling water heated by the water-cooled condenser 53 flows from the cooling water flow passage 71 into the first cooling water circuit 60 via the switching valve 91, and passes through the external heat radiator 64. Accordingly, the heat of the cooling water is radiated to the outside. The cooling water cooled by passing through the external heat radiator 64 returns to the cooling water flow passage 71 again via the cooling water flow passage 62, the switching valve 91, the cooling water flow passage 72, and the switching valve 92. In this way, the heat of the refrigerant radiated to the cooling water by the water-cooled condenser 53 is radiated to the outside by the first cooling water circuit 60 and the second cooling water circuit 70.

The refrigerant liquefied by the water-cooled condenser 53 is decompressed and expanded by the variable throttle mechanism 54 and flows into the chiller 55. The chiller 55 performs heat exchange between the refrigerant decompressed and expanded by the variable throttle mechanism 54 and the cooling water flowing through the third cooling water circuit 80. Specifically, the refrigerant expanded by the variable throttle mechanism 54 is evaporated, and thereby the cooling water flowing through the third cooling water circuit 80 is cooled.

The air-conditioning refrigerant does not flow into the heat exchanger 49 (the heat exchange is not performed by the heat exchanger 49). Therefore, the temperature of the cooling water cooled by the chiller 55 does not change even after passing through the heat exchanger 49.

In the cooling water flow passage 82, the heat exchange is performed between the cooling water cooled by the chiller 55 and the battery 84. That is, the battery 84 is cooled with the cooling water cooled by the chiller 55.

As described above, the temperature adjustment system 1 is switched to the first cooling mode by only switching the switching valve 91, the switching valve 92, the switching valve 86, and the variable throttle mechanism 41a. In the first cooling mode, the switching valve 91 connects the first cooling water circuit 60 and the second cooling water circuit 70, and the switching valve 92 disconnects the second cooling water circuit 70 and the third cooling water circuit 80. Accordingly, the cooling water flowing through the third cooling water circuit 80 is cooled by the heat exchange with the refrigerant flowing through the refrigeration cycle circuit 50. That is, the temperature of the battery 84 can be lowered by lowering the temperature of the cooling water flowing through the third cooling water circuit 80.

<Heating Mode>

FIG. 5 is a diagram illustrating the heating mode of the temperature adjustment system 1. The heating mode is a mode in which the temperature adjustment system 1 operates in a situation where it is necessary to increase or maintain the temperature of the battery 84, or to slow down a temperature drop thereof.

In the heating mode, the switching valve 91 is switched to the disconnection state, and the switching valve 92 is switched to the connection state. That is, the switching valve 91 disconnects the first cooling water circuit 60 and the second cooling water circuit 70, and the switching valve 92 connects the second cooling water circuit 70 and the third cooling water circuit 80. Further, the switching valve 86 is switched to connect the cooling water flow passage 81 and the cooling water flow passage 82, and block the cooling water flow passage 81 and the bypass flow passage 85.

Further, in the heating mode, the variable throttle mechanism 41a is set to the close state for blocking the bypass flow passage 41d (blocking the connection between the gas-liquid separator 45 and the heat exchanger 49). That is, the air-conditioning refrigerant does not flow into the heat exchanger 49, and thus similar to the first cooling mode, in the heating mode, the heat exchange is not performed between the air-conditioning refrigerant and the cooling water flowing through the third cooling water circuit 80. The states of the variable throttle mechanisms 41b and 41c in the heating mode and the arrangement of the air mix door 5 are not particularly limited, and are optional. That is, the temperature adjustment system 1 is switched to the heating mode by only switching the switching valve 91, the switching valve 92, the switching valve 86, and the variable throttle mechanism 41a.

In the heating mode, the heat exchange between the refrigerant compressed by the electric compressor 52 and the cooling water flowing through the cooling water flow passage 71 is performed in the water-cooled condenser 53. Accordingly, the refrigerant is liquefied, and the cooling water flowing through the cooling water flow passage 71 is heated.

The cooling water heated by the water-cooled condenser 53 flows from the cooling water flow passage 71 into the cooling water flow passage 82 via the switching valve 91, the cooling water flow passage 72, the switching valve 92, the cooling water flow passage 81 (the heat exchanger 49), the pump 87, and the switching valve 86. As described above, the air-conditioning refrigerant does not flow into the heat exchanger 49 (the heat exchange is not performed in the heat exchanger 49), and thus the temperature of the cooling water heated by the water-cooled condenser 53 does not change even after passing through the heat exchanger 49.

In the cooling water flow passage 82, the heat exchange is performed between the cooling water heated by the water-cooled condenser 53 and the battery 84. That is, the battery 84 is heated by the cooling water heated by the water-cooled condenser 53.

The cooling water that has heated the battery 84 is guided to the cooling water flow passage 83 and flows through the chiller 55. The cooling water is cooled by the heat exchange with the refrigerant decompressed and expanded by the variable throttle mechanism 54.

The cooling water cooled by the chiller 55 flows into the water-cooled condenser 53 again via the cooling water flow passage 83, the switching valve 92, and the cooling water flow passage 71, and is heated by the heat of the refrigerant radiated by the water-cooled condenser 53.

Here, in the refrigeration cycle circuit 50, the refrigerant is compressed by the electric compressor 52, and thus an amount of the heat radiated from the refrigerant to the cooling water by the water-cooled condenser 53 is the sum of an amount of the heat received by the refrigerant from the cooling water via the chiller 55 and an amount of the heat generated when the refrigerant is compressed by the electric compressor 52. That is, the cooling water receives, by the water-cooled condenser 53, an amount of the heat larger than the amount of the heat radiated by the chiller 55. Therefore, the temperature of the cooling water heated by the water-cooled condenser 53 is higher than the temperature of the cooling water before being cooled by the chiller 55 (the temperature of the cooling water after the battery 84 is heated). Therefore, the battery 84 is heated by performing the heat exchange between the cooling water heated by the water-cooled condenser 53 and the battery 84.

In the heating mode, the first cooling water circuit 60 that radiates the heat of the cooling water to the outside is disconnected from the second cooling water circuit 70 and the third cooling water circuit 80. Therefore, the cooling water heated by the water-cooled condenser 53 is not cooled before being subjected to the heat exchange with the battery 84.

In this way, the temperature adjustment system 1 is switched to the heating mode by only switching the switching valve 91, the switching valve 92, the switching valve 86, and the variable throttle mechanism 41a. In the heating mode, the switching valve 91 disconnects the first cooling water circuit 60 and the second cooling water circuit 70, and the switching valve 92 connects the second cooling water circuit 70 and the third cooling water circuit 80. Accordingly, the cooling water flowing through the third cooling water circuit 80 is heated by the heat exchange with the refrigerant flowing through the refrigeration cycle circuit 50. That is, the temperature of the battery 84 can be raised by raising the temperature of the cooling water flowing through the third cooling water circuit 80 that is subjected to the heat exchange with the battery 84.

<Second Cooling Mode>

FIG. 6 is a diagram illustrating the second cooling mode of the temperature adjustment system 1. The second cooling mode is a mode in which the temperature adjustment system 1 operates in a situation where it is further necessary to cool the battery 84 as compared with the first cooling mode (for example, a situation where it is desired to rapidly charge the battery 84). That is, the second cooling mode is a maximum cooling mode of the battery 84.

In the second cooling mode, the switching valve 91 is switched to the connection state, and the switching valve 92 is switched to the disconnection state. That is, the switching valve 91 connects the first cooling water circuit 60 and the second cooling water circuit 70, and the switching valve 92 disconnects the second cooling water circuit 70 and the third cooling water circuit 80. Further, the switching valve 86 is switched to connect the cooling water flow passage 81 and the cooling water flow passage 82, and block the cooling water flow passage 81 and the bypass flow passage 85.

Further, in the second cooling mode, the variable throttle mechanism 41a is set to the throttled state for decompressing and expanding the air-conditioning refrigerant flowing in from the gas-liquid separator 45. The variable throttle mechanism 41b is set to the close state for blocking the passage of the air-conditioning refrigerant. The variable throttle mechanism 41c is set to the open state for allowing the passage of the air-conditioning refrigerant. Further, the switching valve 46 is set to the close state such that the air-conditioning refrigerant in the liquid phase flows from the gas-liquid separator 45 into the variable throttle mechanism 41a, and the air-conditioning refrigerant in the gas phase guided from the outdoor heat exchanger 44 does not flow into the electric compressor 42.

Similar to the first cooling mode, in the second cooling mode, the cooling water flowing through the cooling water flow passage 71 is heated by the water-cooled condenser 53, and the cooling water flowing through the cooling water flow passage 83 is cooled by the chiller 55. The cooling water heated by the water-cooled condenser 53 passes through the external heat radiator 64 to radiate the heat to the outside, and then returns to the cooling water flow passage 71 again.

In the third cooling water circuit 80, the cooling water cooled by the chiller 55 flows into the cooling water flow passage 81 (the heat exchanger 49) via the switching valve 92.

Here, the air-conditioning refrigerant flows into the heat exchanger 49. Specifically, in the heat pump unit 4, the air-conditioning refrigerant compressed by the electric compressor 42 flows into the outdoor heat exchanger 44 via the heater core 43 and the variable throttle mechanism 41c while keeping the high-temperature and high-pressure state. In the outdoor heat exchanger 44, the air-conditioning refrigerant is subjected to the heat exchange with the air passing through the outdoor heat exchanger 44 and is liquefied. The air-conditioning refrigerant liquefied by the outdoor heat exchanger 44 flows into the variable throttle mechanism 41a via the check valve 41f, the gas-liquid separator 45, and the bypass flow passage 41d, is decompressed and expanded by the variable throttle mechanism 41a and flows into the heat exchanger 49 again.

The heat exchanger 49 performs heat exchange between the air-conditioning refrigerant expanded by the variable throttle mechanism 41a and the cooling water flowing through the cooling water flow passage 81 of the third cooling water circuit 80, and cools the cooling water.

Specifically, the air-conditioning refrigerant decompressed and expanded by the variable throttle mechanism 41a is subjected to the heat exchange with the cooling water flowing through the cooling water flow passage 81 by the heat exchanger 49 and is vaporized. The vaporized air-conditioning refrigerant flows into the electric compressor 42 again via the bypass flow passage 41d and the gas-liquid separator 45. On the other hand, the cooling water flowing through the cooling water flow passage 81 (the cooling water cooled by the chiller 55) is subjected to the heat exchange with the air-conditioning refrigerant, and is further cooled. With the heat exchange by the heat exchanger 49, the cooling water flowing through the cooling water flow passage 81 is further cooled as compared with the first cooling mode.

The cooling water cooled by the chiller 55 and the heat exchanger 49 flows into the cooling water flow passage 82 via the pump 87 and the switching valve 86. In the cooling water flow passage 82, the heat exchange between the cooling water and the battery 84 is performed, and the battery 84 is further cooled as compared with the first cooling mode.

In this way, the temperature adjustment system 1 is switched to the second cooling mode by switching the switching valve 91, the switching valve 92, the switching valve 86, the variable throttle mechanisms 41a to 41c, and the switching valve 46. In the second cooling mode, the switching valve 91 connects the first cooling water circuit 60 and the second cooling water circuit 70, and the switching valve 92 disconnects the second cooling water circuit 70 and the third cooling water circuit 80. Accordingly, the cooling water flowing through the third cooling water circuit 80 is cooled by the heat exchange with the refrigerant in the refrigeration cycle circuit 50, and is also cooled by the heat exchange with the air-conditioning refrigerant in the heat exchanger 49. That is, the temperature of the battery 84 can be further lowered as compared with the first cooling mode by further lowering the temperature of the cooling water flowing through the third cooling water circuit 80 that is subjected to the heat exchange with the battery 84 as compared with the first cooling mode.

<Auxiliary Heating Mode>

FIG. 7 is a diagram illustrating the auxiliary heating mode of the temperature adjustment system 1. The auxiliary heating mode is a mode in which the temperature adjustment system 1 operates in a situation where the heating in the vehicle interior cannot be sufficiently performed in the heating mode (for example, a situation where the outdoor heat exchanger 44 cannot sufficiently absorb heat from the outside air since the outside air has an extremely low temperature (for example, −20° C. or lower)).

In the auxiliary heating mode, the switching valve 91 is switched to the disconnection state, and the switching valve 92 is switched to the connection state. That is, the switching valve 91 disconnects the first cooling water circuit 60 and the second cooling water circuit 70, and the switching valve 92 connects the second cooling water circuit 70 and the third cooling water circuit 80. Further, the switching valve 86 is switched to block the cooling water flow passage 81 and the cooling water flow passage 82, and connect the cooling water flow passage 81 and the bypass flow passage 85. That is, in the auxiliary heating mode, since the cooling water does not flow through the cooling water flow passage 82, the temperature adjustment of the battery 84 is not performed.

Further, in the auxiliary heating mode, the variable throttle mechanism 41a is set to the throttled state for decompressing and expanding the air-conditioning refrigerant flowing in from the gas-liquid separator 45. The variable throttle mechanism 41b is set to the open state for allowing the passage of the air-conditioning refrigerant flowing in from the heater core 43. The variable throttle mechanism 41c is set to the close state for blocking the passage of the air-conditioning refrigerant. That is, in the auxiliary heating mode, the air-conditioning refrigerant does not flow to the outdoor heat exchanger 44. Further, the switching valve 46 is switched to the close state such that the air-conditioning refrigerant in the liquid phase flows from the gas-liquid separator 45 into the variable throttle mechanism 41a, and the air-conditioning refrigerant in the gas phase guided from the outdoor heat exchanger 44 does not flow into the electric compressor 42.

Similar to the heating mode, in the auxiliary heating mode, the cooling water flowing through the cooling water flow passage 71 is heated by the water-cooled condenser 53. The cooling water heated by the water-cooled condenser 53 flows into the cooling water flow passage 81 (the heat exchanger 49) via the switching valve 91, the cooling water flow passage 72, and the switching valve 92.

Here, the air-conditioning refrigerant flows into the heat exchanger 49. Specifically, in the heat pump unit 4, the air-conditioning refrigerant compressed by the electric compressor 42 and flowed into the heater core 43 is subjected to the heat exchange with the air passing through the heater core 43 and is liquefied. The air-conditioning refrigerant liquefied by the heater core 43 flows into the variable throttle mechanism 41a via the variable throttle mechanism 41b, the bypass flow passage 41e, the gas-liquid separator 45, and the bypass flow passage 41d. The air-conditioning refrigerant is decompressed and expanded by the variable throttle mechanism 41a and flows into the heat exchanger 49. The check valve 41f is provided between the outdoor heat exchanger 44 and the gas-liquid separator 45. Therefore, the air-conditioning refrigerant that has flowed into the bypass flow passage 41e does not circulate to the bypass flow passage 41e again via the outdoor heat exchanger 44 and the variable throttle mechanism 41c.

The heat exchanger 49 performs heat exchange between the air-conditioning refrigerant expanded by the variable throttle mechanism 41a and the cooling water heated by the water-cooled condenser 53 and flowing through the third cooling water circuit 80 (the cooling water flow passage 81). That is, the heat exchanger 49 heats and vaporizes the air-conditioning refrigerant by the heat exchange with the cooling water flowing through the third cooling water circuit 80.

The air-conditioning refrigerant vaporized by the heat exchanger 49 is supplied to the electric compressor 42 via the bypass flow passage 41d and the gas-liquid separator 45. The air-conditioning refrigerant is compressed by the electric compressor 42 to be in a high-temperature state, and flows into the heater core 43.

In the heater core 43, the air passing through the heater core 43 is heated by the air-conditioning refrigerant. The air that has passed through the heater core 43 and is heated is guided from the air passage 2 into the vehicle interior.

The cooling water that has heated the air-conditioning refrigerant in the heat exchanger 49 flows through the bypass flow passage 85 and is guided to the cooling water flow passage 83 (the chiller 55). The cooling water guided to the cooling water flow passage 83 (the chiller 55) is liquefied by the water-cooled condenser 53 and is cooled by the heat exchange with the refrigerant decompressed and expanded by the variable throttle mechanism 54. The cooling water cooled by the chiller 55 flows into the water-cooled condenser 53 again via the cooling water flow passage 83, the switching valve 92, and the cooling water flow passage 71. The cooling water is heated by the heat of the refrigerant radiated by the water-cooled condenser 53.

In this way, the temperature adjustment system 1 is switched to the auxiliary heating mode by switching the switching valve 91, the switching valve 92, the switching valve 86, the variable throttle mechanisms 41a to 41c, and the switching valve 46. In the auxiliary heating mode, by cooperating the heat pump unit 4 with the temperature adjustment circuit 100 and heating the air-conditioning refrigerant by the heat generated by the refrigeration cycle circuit 50, the vehicle interior is sufficiently heated even in a situation where the heating of the vehicle interior cannot be sufficiently performed in the heating mode.

Here, when it is assumed that the temperature adjustment system 1 does not include the temperature adjustment circuit 100, it is conceivable to increase a size of the electric compressor 42 or provide a heater (for example, a positive temperature coefficient (PTC) heater) different from the heater core 43 in order to cope with the situation where the heating in the vehicle interior cannot be sufficiently performed.

However, when the size of the electric compressor 42 is increased, there is a risk that the efficiency of the electric compressor 52 in a situation other than the situation where the heating in the vehicle interior cannot be sufficiently performed (for example, the cooling mode or the heating mode) may be reduced.

In addition, when the heater different from the heater core 43 is provided, a high-voltage power supply and a management system for the high-voltage power supply for operating the different heater are also required, complicating the entire system.

Regarding the above problems, since the heat pump unit 4 and the temperature adjustment circuit 100 are provided in the temperature adjustment system 1, it is possible to avoid the increase in the size of the electric compressor 42, and to apply the electric compressor 42 having a size suitable for all the modes. That is, in all the modes, the efficiency of the electric compressor 42 can be improved.

In addition, it is possible to sufficiently heat the vehicle interior in the situation where the heating in the vehicle interior cannot be sufficiently performed without providing the heater different from the heater core 43 in the temperature adjustment system 1. That is, the high-voltage power supply and the management system for the high-voltage power supply for providing the heater different from the heater core 43 can be omitted, and the entire system can be simplified.

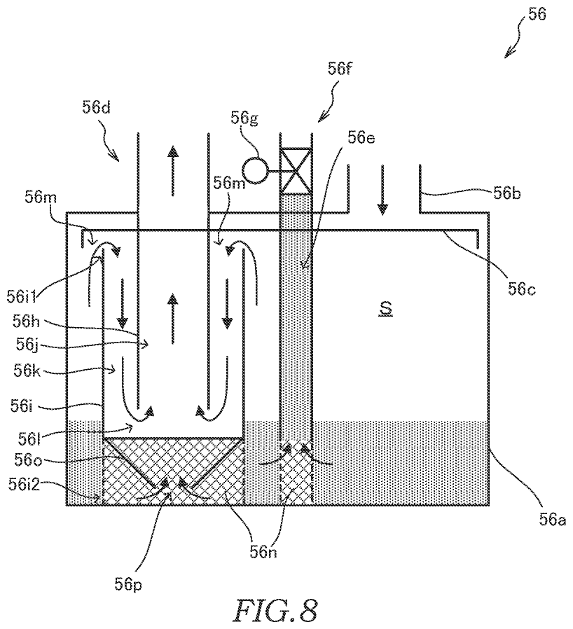

Next, the gas-liquid separator 56 included in the refrigeration cycle circuit 50 of the temperature adjustment circuit 100 will be described with reference to FIG. 8. FIG. 8 is a schematic configuration diagram of the gas-liquid separator 56 provided in the refrigeration cycle circuit 50 of the temperature adjustment system 1.

The gas-liquid separator 56 includes a tank portion 56a, an inlet pipe 56b through which the refrigerant that has flowed out of the chiller 55 flows into the tank portion 56a, a separation member 56c that separates the refrigerant that has flowed in from the inlet pipe 56b into a gas phase refrigerant and a liquid phase refrigerant, a first outlet pipe 56d that supplies the gas phase refrigerant and the liquid phase refrigerant in the tank portion 56a to the electric compressor 52, a second outlet pipe 56f in which a flow passage 56e for mixing the liquid phase refrigerant in the tank portion 56a with the gas phase refrigerant to be supplied to the electric compressor 52 is formed, and a variable throttle mechanism 56g that adjusts an opening degree of the flow passage 56e in the second outlet pipe 56f to increase or decrease a flow rate of the liquid phase refrigerant flowing through the flow passage 56e.

The tank portion 56a is formed in a cylindrical shape with a bottom, and a space S for storing the refrigerant is formed therein. The inlet pipe 56b is connected to an upper portion of the tank portion 56a. The inlet pipe 56b is provided with a refrigerant temperature sensor (not shown) for detecting the temperature of the refrigerant and a refrigerant pressure sensor (not shown) for detecting a pressure of the refrigerant. Information on the temperature and the pressure of the refrigerant detected by the two sensors is transmitted to the controller.

The separation member 56c is formed in a tubular shape with a bottom, and is provided in an upper portion in the tank portion 56a such that the bottom is positioned at an upper portion. The refrigerant that has flowed out of the chiller 55 and has flowed into the tank portion 56a via the inlet pipe 56b collides with the separation member 56c to be separated into the gas phase refrigerant and the liquid phase refrigerant. The liquid phase refrigerant separated by the separation member 56c descends toward an outer edge side of the tank portion 56a along an inner peripheral surface of the tank portion 56a. Accordingly, the gas phase refrigerant accumulates in an upper portion of the space S, and the liquid phase refrigerant accumulates in a lower portion of the space S.

The refrigerant circulating through the refrigeration cycle circuit 50 is mixed with a lubricating oil for lubricating the components constituting the refrigeration cycle circuit 50. The lubricating oil accumulates in the lower portion of the space S in a state of being mixed with the liquid phase refrigerant.

The first outlet pipe 56d includes an inner pipe portion 56h and an outer pipe portion 56i.

The inner pipe portion 56h is formed in a pipe shape whose both ends are open, and a flow passage 56j through which the gas phase refrigerant and the liquid phase refrigerant can flow is formed therein. One end of the inner pipe portion 56h is coupled to the electric compressor 52 via the refrigerant circulation circuit 51 (not shown). Accordingly, the flow passage 56j is connected to the electric compressor 52 (not shown). The other end of the inner pipe portion 56h is provided to be positioned at a position where the lubricating oil is sucked up from a through hole 56p, which is an oil bleeding hole, in the space S.

The outer pipe portion 56i is formed in a shape having an inner diameter larger than an outer diameter of the inner pipe portion 56h. The outer pipe portion 56i is provided on an outer periphery of the inner pipe portion 56h. Accordingly, an annular flow passage 56k is formed between the inner diameter of the outer pipe portion 56i and the outer diameter of the inner pipe portion 56h. The flow passage 56k and the flow passage 56j are connected by a flow passage 56l (a flow passage formed by the other end side of the inner pipe portion 56h and the inner peripheral surface of the outer pipe portion 56i).

One end 56i1 of the outer pipe portion 56i is provided at a position facing the bottom of the separation member 56c at an interval. Accordingly, an inlet 56m through which the refrigerant can flow into the flow passage 56k is formed between the one end 56i1 of the outer pipe portion 56i and the separation member 56c.

The other end 56i2 of the outer pipe portion 56i is provided to be always positioned below a liquid level of the liquid phase refrigerant stored in the space S. A mesh portion 56n is provided on an outer periphery of the outer pipe portion 56i on the other end 56i2 side. The mesh portion 56n traps an impurity contained in the liquid phase refrigerant and allows the liquid phase refrigerant to pass therethrough. That is, the other end 56i2 side of the outer pipe portion 56i has a structure into which the liquid phase refrigerant can flow. An induction member 56o is provided inside the outer pipe portion 56i on the other end 56i2 side.

The induction member 56o is a member having a dish shape, a diameter of an upper end portion thereof is equal to the inner diameter of the outer pipe portion 56i, and a bottom surface thereof is formed with the through hole 56p through which the liquid phase refrigerant can flow. The through hole 56p is formed to have a size that allows the lubricating oil in an amount required for lubricating the components of the refrigeration cycle circuit 50 to flow into the flow passage 56l. The induction member 56o is held in the outer pipe portion 56i such that the through hole 56p is always positioned below the liquid level of the liquid phase refrigerant stored in the space S.

The gas phase refrigerant stored in the space S is supplied to the electric compressor 52 via the inlet 56m and the flow passages 56k, 56l and 56j. Further, a part of the liquid phase refrigerant stored in the space S flows into the outer pipe portion 56i after the impurity is removed by the mesh portion 56n, and flows into the flow passage 56l from the through hole 56p. The liquid phase refrigerant that has flowed into the flow passage 56l is mixed with the gas phase refrigerant that has flowed into the flow passage 56l from the flow passage 56k, and the mixed refrigerant flows into the flow passage 56j and is supplied to the electric compressor 52. Accordingly, a mixed refrigerant of the gas phase refrigerant and the liquid phase refrigerant in an amount required to lubricate the components of the refrigeration cycle circuit 50 is supplied to the electric compressor 52. The electric compressor 52 is lubricated by the lubricating oil contained in the refrigerant.

The second outlet pipe 56f is formed in a pipe shape whose both ends are open. The flow passage 56e through which the liquid phase refrigerant can flow is formed inside the second outlet pipe 56f. Outside the gas-liquid separator 56, one end of the second outlet pipe 56f is coupled to the inner pipe portion 56h of the first outlet pipe 56d that supplies the gas phase refrigerant to the electric compressor 52 (not shown). Accordingly, the flow passage 56j and the flow passage 56e are connected to each other.

The other end of the second outlet pipe 56f is provided to be always positioned below the liquid level of the liquid phase refrigerant stored in the space S. Similar to the other end 56i2 side of the outer pipe portion 56i, a mesh portion 56n is provided on an outer periphery of the second outlet pipe 56f on the other end side. Therefore, a part of the liquid phase refrigerant stored in the space S flows through the mesh portion 56n to remove the impurity, and then flows into the flow passage 56e.

The second outlet pipe 56f is provided with the variable throttle mechanism 56g serving as an on-off switching mechanism that adjusts the opening degree of the flow passage 56e to increase or decrease the flow rate of the liquid phase refrigerant flowing through the flow passage 56e. An opening degree of the variable throttle mechanism 56g is controlled by the controller.

The flow passage 56e of the second outlet pipe 56f supplies the liquid phase refrigerant stored in the space S to the flow passage 56j according to the opening degree adjusted by the variable throttle mechanism 56g. In other words, the flow passage 56e functions as a flow passage for mixing the liquid phase refrigerant with the gas phase refrigerant to be supplied from the first outlet pipe 56d (the flow passage 56j) to the electric compressor 52.

Next, effects of the gas-liquid separator 56 in the operation modes of the temperature adjustment system 1 will be described.

First, a case where the temperature of the battery 84 is to be raised (the heating mode) will be described. In this case, as described in the description for the heating mode (see FIG. 5), the battery 84 in a low-temperature state is heated by the heat exchange with the cooling water flowing through the third cooling water circuit 80.

Here, in the chiller 55, the heat exchange is performed between the cooling water whose heat is taken away by the battery 84 and the refrigerant (see FIG. 5). Therefore, the temperature of the refrigerant flowing out of the chiller 55 and flowing into the gas-liquid separator 56 is equal to or lower than a predetermined value, and the pressure thereof is equal to or lower than a predetermined value.

The controller calculates the temperature and the pressure of the refrigerant flowing into the gas-liquid separator 56 based on detection values received from the refrigerant temperature sensor and the refrigerant pressure sensor provided in the inlet pipe 56b, and compares the calculated temperature and the calculated pressure of the refrigerant with the predetermined value of the temperature and the predetermined value of the pressure of the refrigerant stored in the controller in advance. When the controller determines that the calculated temperature or the calculated pressure of the refrigerant is equal to or lower than the predetermined value, the controller controls the variable throttle mechanism 56g to increase the opening degree of the flow passage 56e such that the liquid phase refrigerant is supplied from the flow passage 56e to the flow passage 56j.

That is, when the temperature of the battery 84 is to be raised, the gas-liquid separator 56 mixes the liquid phase refrigerant, via the flow passage 56e of the second outlet pipe 56f, with the refrigerant flowing through the flow passage 56j of the first outlet pipe 56d (the gas phase refrigerant and the liquid phase refrigerant in an amount required to lubricate the components of the refrigeration cycle circuit 50), and supplies the refrigerant (the gas phase refrigerant and the liquid phase refrigerant) having an increased mixing ratio of the liquid phase refrigerant to the electric compressor 52. The amount of the liquid phase refrigerant mixed with the gas phase refrigerant is set within a range of an allowable amount of the liquid phase refrigerant that can be received by the electric compressor 52. This is to reduce an influence of the flowing in of the liquid phase refrigerant on the electric compressor 52.

By supplying the refrigerant (the gas phase refrigerant and the liquid phase refrigerant) having an increased mixing ratio of the liquid phase refrigerant to the electric compressor 52, a density of the refrigerant supplied to the electric compressor 52 is increased, and the flow rate of the refrigerant supplied from the electric compressor 52 to the water-cooled condenser 53 is increased. Accordingly, since the amount of the heat radiated by the water-cooled condenser 53 increases, a performance of heating the cooling water flowing through the cooling water flow passage 83 (the cooling water for exchanging heat with the battery 84) by the water-cooled condenser 53 is improved. Therefore, the battery 84 can be further heated.

Next, a case where the temperature of the battery 84 is to be lowered (the first cooling mode and the second cooling mode) will be described. In this case, as described in the description for the first cooling mode (see FIG. 4) and the second cooling mode (see FIG. 6), the battery 84 in the high-temperature state is cooled by the heat exchange with the cooling water flowing through the third cooling water circuit 80.

Here, in the chiller 55, the heat exchange is performed between the cooling water heated by the battery 84 and the refrigerant (see FIGS. 4 and 6). Therefore, the temperature of the refrigerant flowing out of the chiller 55 and flowing into the gas-liquid separator 56 is higher than the predetermined value, and the pressure thereof is higher than the predetermined value.

The controller calculates the temperature and the pressure of the refrigerant flowing into the gas-liquid separator 56 based on the detection values received from the refrigerant temperature sensor and the refrigerant pressure sensor provided in the inlet pipe 56b, and compares the calculated temperature and the calculated pressure of the refrigerant with the predetermined value of the temperature and the predetermined value of the pressure of the refrigerant stored in the controller in advance. When the controller determines that the calculated temperature or the calculated pressure of the refrigerant is higher than the predetermined value, the controller controls the variable throttle mechanism 56g to decrease the opening degree of the flow passage 56e to such an extent that the liquid phase refrigerant is not supplied from the flow passage 56e to the flow passage 56j.

That is, when the temperature of the battery 84 is to be lowered, the gas-liquid separator 56 does not supply the liquid phase refrigerant from the second outlet pipe 56f. Therefore, as compared with the case where the temperature of the battery 84 is to be raised, the density of the refrigerant supplied to the electric compressor 52 decreases, and the flow rate of the refrigerant supplied from the electric compressor 52 to the water-cooled condenser 53 decreases.

When the flow rate of the refrigerant supplied from the electric compressor 52 to the water-cooled condenser 53 decreases, the flow rate of the refrigerant flowing into the variable throttle mechanism 54 also decreases, and an expansion coefficient of the refrigerant in the variable throttle mechanism 54 increases accordingly. Accordingly, the amount of the heat absorbed from the cooling water due to the vaporization of the refrigerant in the chiller 55 is increased, and thus a performance of cooling the cooling water flowing through the cooling water flow passage 83 (the cooling water for exchanging heat with the battery 84) by the chiller 55 is improved. Therefore, the battery 84 can be further cooled.

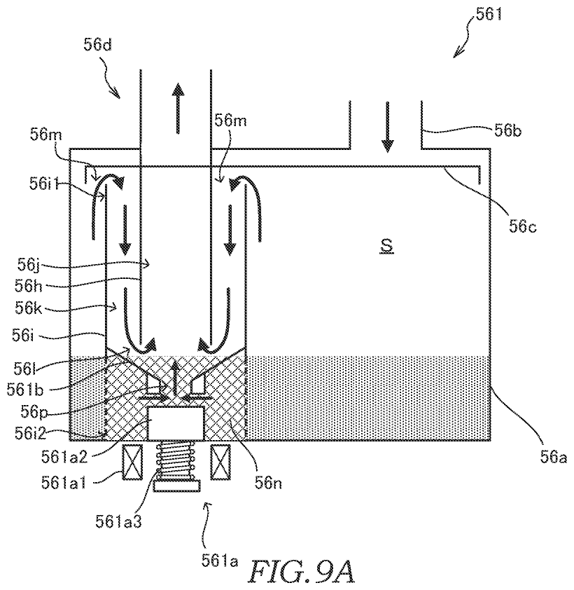

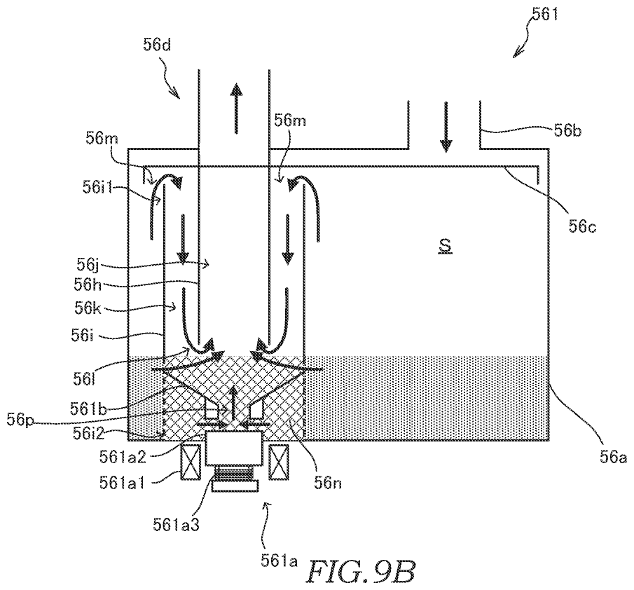

Next, first to fifth modifications of the gas-liquid separator 56 will be described with reference to FIGS. 9A to 13B.

First, a gas-liquid separator 561 according to the first modification will be described with reference to FIGS. 9A and 9B. FIG. 9A is a schematic configuration diagram of the gas-liquid separator 561 in the case where the temperature adjustment system 1 lowers the temperature of the battery 84 (the first cooling mode and the second cooling mode). FIG. 9B is a schematic configuration diagram of the gas-liquid separator 561 in the case where the temperature adjustment system 1 raises the temperature of the battery 84 (the heating mode). In FIGS. 9A and 9B, the same components as those of the gas-liquid separator 56 are denoted by the same reference numerals, and the description thereof is omitted.

The gas-liquid separator 561 is different from the gas-liquid separator 56 in that the second outlet pipe 56f is not included. Further, the gas-liquid separator 561 is different from the gas-liquid separator 56 in that an induction member 561b movable in the outer pipe portion 56i by an electromagnetic valve 561a is included instead of the induction member 56o.

As illustrated in FIGS. 9A and 9B, the gas-liquid separator 561 includes the induction member 561b and the electromagnetic valve 561a serving as an on-off switching mechanism for increasing or decreasing the flow rate of the liquid phase refrigerant flowing through the flow passage 56l.

In a bottom surface of the tank portion 56a, the electromagnetic valve 561a is provided at a position facing the other end 56i2 side of the outer pipe portion 56i. The electromagnetic valve 561a includes a solenoid portion 561a1 and a valve portion 561a2. The solenoid portion 561a1 is provided outside the tank portion 56a. The valve portion 561a2 is inserted into the other end 56i2 side of the outer pipe portion 56i from the outside of the tank portion 56a. The valve portion 561a2 is biased by a return spring 561a3 in a direction of retracting from the tank portion 56a. The electromagnetic valve 561a moves the valve portion 561a2 according to an energized state controlled by the controller.

The induction member 561b is a member having a dish shape, a diameter of an upper end portion thereof is equal to the inner diameter of the outer pipe portion 56i, and a bottom surface thereof is formed with the through hole 56p. The induction member 561b is provided to be movable in an axial direction on an inner periphery of the outer pipe portion 56i on the other end 56i2 side. The induction member 561b is coupled to the valve portion 561a2 of the electromagnetic valve 561a.

As illustrated in FIG. 9A, when the valve portion 561a2 of the electromagnetic valve 561a moves to be inserted into the tank portion 56a, the induction member 561b also moves in conjunction with the movement. In this case, the induction member 561b is held at a position where the upper end portion thereof is higher than an upper end of the mesh portion 56n and is also higher than the liquid surface of the liquid phase refrigerant stored in the tank portion 56a. In this case, the liquid phase refrigerant flows into the flow passage 56l only via the through hole 56p.

As illustrated in FIG. 9B, when the valve portion 561a2 of the electromagnetic valve 561a moves to retract from the tank portion 56a, the induction member 561b also moves in conjunction with the movement. In this case, the induction member 561b is held at a position where the upper end portion thereof is lower than the upper end of the mesh portion 56n and is also lower than the liquid surface of the liquid phase refrigerant stored in the tank portion 56a. In this case, in addition to the through hole 56p, the refrigerant flows into the flow passage 56l also via the mesh portion 56n upper than the upper end portion of the induction member 561b.

That is, in the case where the induction member 561b is positioned at the position in FIG. 9B, the liquid phase refrigerant in an amount larger than that in the case where the induction member 561b is positioned at the position in FIG. 9A can be flowed into the flow passage 56l. In other words, the opening degree of the flow passage 56l in the case where the induction member 561b is positioned at the position illustrated in FIG. 9B is larger than that in the case where the induction member 561b is positioned at the position illustrated in FIG. 9A.

In this way, by moving the position of the induction member 561b with the electromagnetic valve 561a, the gas-liquid separator 561 can adjust the opening degree of the flow passage 56l to increase or decrease the amount of the liquid phase refrigerant flowing through the flow passage 56l. In the following description, the case where the induction member 561b is positioned at the position illustrated in FIG. 9A is referred to as “the induction member 561b is positioned at the closing position”, and the case where the induction member 561b is positioned at the position illustrated in FIG. 9B is referred to as “the induction member 561b is positioned at the opening position”.

Next, effects of the gas-liquid separator 561 in the operation modes of the temperature adjustment system 1 will be described.

First, the case where the temperature of the battery 84 is to be raised (the heating mode) will be described. In this case, the temperature of the refrigerant flowing into the gas-liquid separator 561 is equal to or lower than the predetermined value, and the pressure thereof is equal to or lower than the predetermined value.

When the controller determines that the temperature or the pressure of the refrigerant is equal to or lower than the predetermined value, the controller controls the electromagnetic valve 561a to move the induction member 561b to the opening position as illustrated in FIG. 9B, and increase the opening degree of the flow passage 56l. Accordingly, the liquid phase refrigerant in an amount larger than that in the case where the induction member 561b is positioned at the closing position flows into the flow passage 56l.

The flow passage 56l mixes the liquid phase refrigerant flowing in due to the movement of the induction member 561b with the gas phase refrigerant flowing in from the flow passage 56k. The refrigerant (the gas phase refrigerant and the liquid phase refrigerant) having an increased mixing ratio of the liquid phase refrigerant due to the flow passage 56l is supplied to the electric compressor 52 via the flow passage 56j. In the gas-liquid separator 561, the amount of the liquid phase refrigerant mixed with the gas phase refrigerant is set within a range of an allowable amount of the liquid phase refrigerant that can be received by the electric compressor 52.

In this way, by supplying the refrigerant (the gas phase refrigerant and the liquid phase refrigerant) having an increased mixing ratio of the liquid phase refrigerant to the electric compressor 52, the density of the refrigerant supplied to the electric compressor 52 increases, and the flow rate of the refrigerant supplied from the electric compressor 52 to the water-cooled condenser 53 increases. Accordingly, since the amount of the heat radiated by the water-cooled condenser 53 increases, the performance of heating the cooling water flowing through the cooling water flow passage 83 (the cooling water for exchanging heat with the battery 84) by the water-cooled condenser 53 is improved. Therefore, the battery 84 can be further heated.

Next, the case where the temperature of the battery 84 is to be lowered (the first cooling mode and the second cooling mode) will be described. In this case, the temperature of the refrigerant flowing into the gas-liquid separator 561 is higher than the predetermined value, and the pressure thereof is higher than the predetermined value.

When the controller determines that the temperature or the pressure of the refrigerant is higher than the predetermined value, the controller controls the electromagnetic valve 561a to move the induction member 561b to the closing position as illustrated in FIG. 9A, and decrease the opening degree of the flow passage 56l. Accordingly, the liquid phase refrigerant in an amount required to lubricate the components of the refrigeration cycle circuit 50 flows into the flow passage 56l only via the through hole 56p.

Therefore, as compared with the case where the temperature of the battery 84 is to be raised, the density of the refrigerant supplied to the electric compressor 52 decreases, and the flow rate of the refrigerant supplied from the electric compressor 52 to the water-cooled condenser 53 decreases.

When the flow rate of the refrigerant supplied from the electric compressor 52 to the water-cooled condenser 53 decreases, the flow rate of the refrigerant flowing into the variable throttle mechanism 54 also decreases, and the expansion coefficient of the refrigerant in the variable throttle mechanism 54 increases accordingly. Accordingly, the amount of the heat absorbed from the cooling water due to the vaporization of the refrigerant in the chiller 55 is increased, and the performance of cooling the cooling water flowing through the cooling water flow passage 83 (the cooling water for exchanging heat with the battery 84) by the chiller 55 is improved. Therefore, the battery 84 can be further cooled.

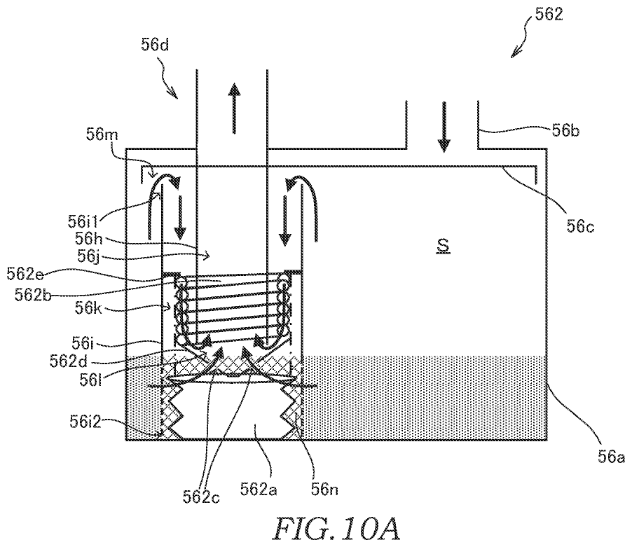

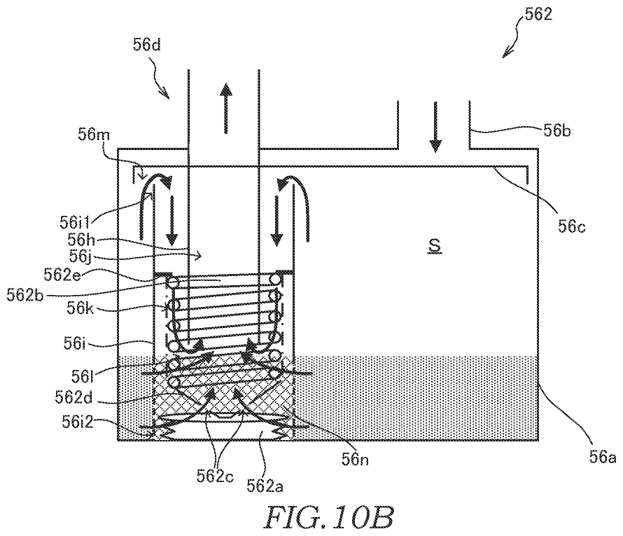

Next, a gas-liquid separator 562 according to the second modification will be described with reference to FIGS. 10A and 10B. FIG. 10A is a schematic configuration diagram of the gas-liquid separator 562 in the case where the temperature adjustment system 1 lowers the temperature of the battery 84 (the first cooling mode and the second cooling mode). FIG. 10B is a schematic configuration diagram of the gas-liquid separator 562 in the case where the temperature adjustment system 1 raises the temperature of the battery 84 (the heating mode). In FIGS. 10A and 10B, the same components as those of the gas-liquid separators 56 and 561 are denoted by the same reference numerals, and the description thereof is omitted.

The gas-liquid separator 562 is different from the gas-liquid separators 56 and 561 in that an induction member 562d is moved by a bellows 562a and an auxiliary spring 562b.

As illustrated in FIGS. 10A and 10B, the gas-liquid separator 562 includes the bellows 562a serving as the on-off switching mechanism for increasing or decreasing the flow rate of the liquid phase refrigerant flowing through the flow passage 56l, the auxiliary spring 562b, and the induction member 562d.

In the bottom surface of the tank portion 56a, the bellows 562a is provided at a position where the other end 56i2 of the outer pipe portion 56i is provided. That is, the bellows 562a is housed in the inner periphery of the other end 56i2 of the outer pipe portion 56i.

The bellows 562a is filled with a gas that expands when an ambient temperature (in the present embodiment, the temperature of the refrigerant in the space S) is higher than the predetermined value and contracts when the ambient temperature is equal to or lower than the predetermined value. When the temperature of the refrigerant in the space S is higher than the predetermined value, the bellows 562a expands as illustrated in FIG. 10A, and when the temperature of the refrigerant in the space S is equal to or lower than the predetermined value, the bellows 562a contracts as illustrated in FIG. 10B.

The auxiliary spring 562b is a spring member having a predetermined elastic force. One end of the auxiliary spring 562b is in contact with a holding portion 562e protruding from the inner peripheral surface of the outer pipe portion 56i, and the other end thereof is in contact with an upper end portion of the induction member 562d, whereby the auxiliary spring 562b is held in the flow passage 56k.

The induction member 562d is a member having a dish shape, and a diameter of the upper end portion thereof is formed larger than the outer diameter of the inner pipe portion 56h. A plurality of through holes 562c are formed in the induction member 562d. The through holes 562c are formed to have a size that allows the liquid phase refrigerant in the amount required for lubricating the components of the refrigeration cycle circuit 50 to flow into the flow passage 56l. The induction member 562d is provided to be movable in the outer pipe portion 56i on the other end 56i2 side. A bottom surface portion of the induction member 562d is coupled to the bellows 562a. The upper end portion of the induction member 562d is in contact with the other end of the auxiliary spring 562b.

As illustrated in FIG. 10A, in the case where the bellows 562a expands when the temperature of the refrigerant in the space S is higher than the predetermined value, the auxiliary spring 562b is contracted and the induction member 562d moves. In this case, the induction member 562d is held at a position where the upper end portion thereof is higher than the upper end of the mesh portion 56n. In this case, the liquid phase refrigerant flows into the flow passage 56l via the through holes 562c.

As illustrated in FIG. 10B, in the case where the bellows 562a contracts when the temperature of the refrigerant in the space S is equal to or lower than the predetermined value, the induction member 562d moves due to a restoring force of the auxiliary spring 562b. In this case, the induction member 562d is held at a position where the upper end portion thereof is lower than the upper end of the mesh portion 56n. In this case, in addition to the through holes 562c, the refrigerant flows into the flow passage 56l also via the mesh portion 56n upper than the upper end portion of the induction member 562d.

That is, in the case where the induction member 562d is positioned at the position in FIG. 10B, the liquid phase refrigerant in an amount larger than that in the case where the induction member 562d is positioned at the position in FIG. 10A can be flowed into the flow passage 56l. In other words, the opening degree of the flow passage 56l in the case where the induction member 562d is positioned at the position illustrated in FIG. 10B is larger than that in the case where the induction member 562d is positioned at the position illustrated in FIG. 10A.

In this way, in the gas-liquid separator 562, the opening degree of the flow passage 56l is automatically changed according to the temperature of the refrigerant in the space S, and the amount of the liquid phase refrigerant flowing into the flow passage 56l can be increased or decreased. Therefore, the sensors for detecting the temperature and the pressure of the refrigerant and the control by the controller as in the gas-liquid separators 56 and 561 are not necessary for the gas-liquid separator 562. In the following description, the case where the induction member 562d is positioned at the position illustrated in FIG. 10A is referred to as “the induction member 562d is positioned at the closing position”, and the case where the induction member 562d is positioned at the position illustrated in FIG. 10B is referred to as “the induction member 562d is positioned at the opening position”.

Next, effects of the gas-liquid separator 562 in the operation modes of the temperature adjustment system 1 will be described.

First, the case where the temperature of the battery 84 is to be raised (the heating mode) will be described. In this case, the temperature of the refrigerant flowing into the gas-liquid separator 562 is equal to or lower than the predetermined value.

When the temperature of the refrigerant flowing into and stored in the space S is equal to or lower than the predetermined value, as illustrated in FIG. 10B, the induction member 562d moves to the opening position, and the opening degree of the flow passage 56l increases. Accordingly, the liquid phase refrigerant in an amount larger than that in the case where the induction member 562d is positioned at the closing position flows into the flow passage 56l.

The flow passage 56l mixes the liquid phase refrigerant flowing in due to the movement of the induction member 562d with the gas phase refrigerant flowing in from the flow passage 56k. The refrigerant (the gas phase refrigerant and the liquid phase refrigerant) having an increased mixing ratio of the liquid phase refrigerant due to the flow passage 56l is supplied to the electric compressor 52 via the flow passage 56j. In the gas-liquid separator 562, the amount of the liquid phase refrigerant mixed with the gas phase refrigerant is set within a range of an allowable amount of the liquid phase refrigerant that can be received by the electric compressor 52.

In this way, by supplying the refrigerant (the gas phase refrigerant and the liquid phase refrigerant) having an increased mixing ratio of the liquid phase refrigerant to the electric compressor 52, the density of the refrigerant supplied to the electric compressor 52 increases, and the flow rate of the refrigerant supplied from the electric compressor 52 to the water-cooled condenser 53 increases. Accordingly, since the amount of the heat radiated by the water-cooled condenser 53 increases, the performance of heating the cooling water flowing through the cooling water flow passage 83 (the cooling water for exchanging heat with the battery 84) by the water-cooled condenser 53 is improved. Therefore, the battery 84 can be further heated.

Next, the case where the temperature of the battery 84 is to be lowered (the first cooling mode and the second cooling mode) will be described. In this case, the temperature of the refrigerant flowing into the gas-liquid separator 562 is higher than the predetermined value.

When the temperature of the refrigerant flowing into and stored in the space S is higher than the predetermined value, as illustrated in FIG. 10A, the induction member 562d moves to the closing position, and the opening degree of the flow passage 56l decreases. Accordingly, the liquid phase refrigerant in an amount required to lubricate the components of the refrigeration cycle circuit 50 flows into the flow passage 56l via the through holes 562c.

Therefore, as compared with the case where the temperature of the battery 84 is to be raised, the density of the refrigerant supplied to the electric compressor 52 decreases, and the flow rate of the refrigerant supplied from the electric compressor 52 to the water-cooled condenser 53 also decreases.

When the flow rate of the refrigerant supplied from the electric compressor 52 to the water-cooled condenser 53 decreases, the flow rate of the refrigerant flowing into the variable throttle mechanism 54 also decreases, and the expansion coefficient of the refrigerant in the variable throttle mechanism 54 increases accordingly. Accordingly, the amount of the heat absorbed from the cooling water due to the vaporization of the refrigerant in the chiller 55 is increased, and thus the performance of cooling the cooling water flowing through the cooling water flow passage 83 (the cooling water for exchanging heat with the battery 84) by the chiller 55 is improved. Therefore, the battery 84 can be further cooled.

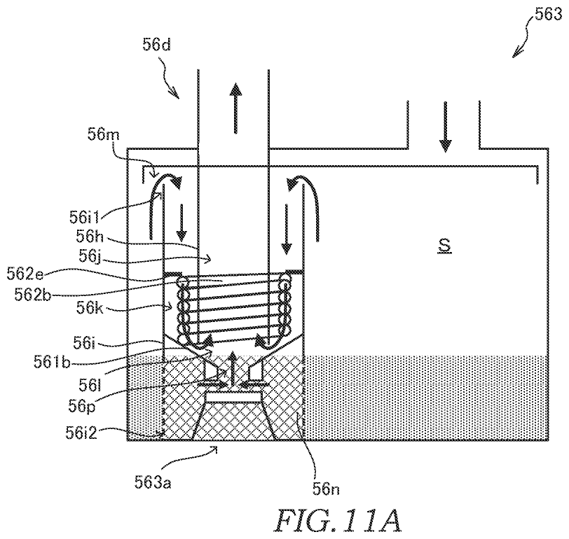

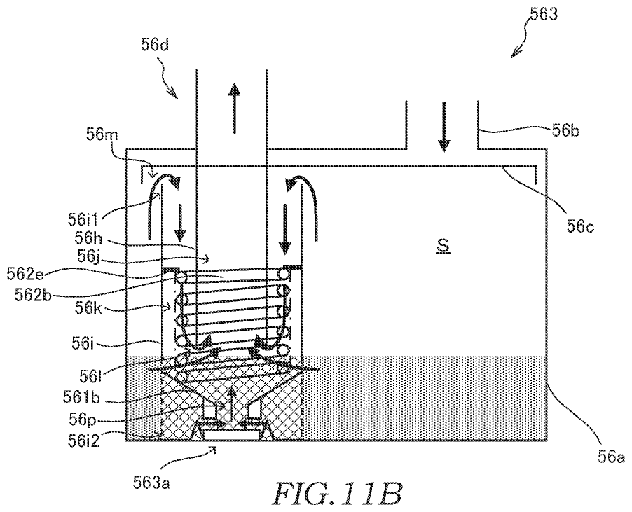

Next, a gas-liquid separator 563 according to the third modification will be described with reference to FIGS. 11A and 11B. FIG. 11A is a schematic configuration diagram of the gas-liquid separator 563 in the case where the temperature adjustment system 1 lowers the temperature of the battery 84 (the first cooling mode and the second cooling mode). FIG. 11B is a schematic configuration diagram of the gas-liquid separator 563 in the case where the temperature adjustment system 1 raises the temperature of the battery 84 (the heating mode). In FIGS. 11A and 11B, the same components as those of the gas-liquid separators 56, 561 and 562 are denoted by the same reference numerals, and the description thereof is omitted.

The gas-liquid separator 563 is different from the gas-liquid separators 56, 561 and 562 in that the induction member 561b is moved by a diaphragm 563a and the auxiliary spring 562b.

As illustrated in FIGS. 11A and 11B, the gas-liquid separator 563 includes the diaphragm 563a serving as the on-off switching mechanism for increasing or decreasing the flow rate of the liquid phase refrigerant flowing through the flow passage 56l, the auxiliary spring 562b, and the induction member 561b.

In the bottom surface of the tank portion 56a, the diaphragm 563a is provided at the position where the other end 56i2 of the outer pipe portion 56i is provided. That is, the diaphragm 563a is housed in the inner periphery of the other end 56i2 of the outer pipe portion 56i.

The diaphragm 563a is filled with a gas that expands when the ambient temperature (in the present embodiment, the temperature of the refrigerant in the space S) is higher than the predetermined value and contracts when the ambient temperature is equal to or lower than the predetermined value. Therefore, when the temperature of the refrigerant in the space S is higher than the predetermined value, the diaphragm 563a expands as illustrated in FIG. 11A, and when the temperature of the refrigerant in the space S is equal to or lower than the predetermined value, the diaphragm 563a contracts as illustrated in FIG. 11B.

As illustrated in FIG. 11A, in the case where the diaphragm 563a expands when the temperature of the refrigerant in the space S is higher than the predetermined value, the auxiliary spring 562b is contracted and the induction member 561b moves. In this case, the induction member 561b is held at a position where the upper end portion thereof is higher than the upper end of the mesh portion 56n. In this case, the liquid phase refrigerant flows into the flow passage 56l only via the through hole 56p.

As illustrated in FIG. 11B, in the case where the diaphragm 563a contracts when the temperature of the refrigerant in the space S is equal to or lower than the predetermined value, the induction member 561b moves due to the restoring force of the auxiliary spring 562b. In this case, the induction member 561b is held at a position where the upper end portion thereof is lower than the upper end of the mesh portion 56n. In this case, in addition to the through holes 562c, the refrigerant flows into the flow passage 56l from the mesh portion 56n upper than the upper end portion of the induction member 561b.

That is, in the case where the induction member 561b is positioned at the position in FIG. 11B, the liquid phase refrigerant in an amount larger than that in the case where the induction member 561b is positioned at the position in FIG. 11A can be allowed to flow into the flow passage 56l. In other words, the opening degree of the flow passage 56l in the case where the induction member 561b is positioned at the position illustrated in FIG. 11B is larger than that in the case where the induction member 561b is positioned at the position illustrated in FIG. 11A.

In this way, in the gas-liquid separator 563, the opening degree of the flow passage 56l is automatically changed according to the temperature of the refrigerant in the space S, and the amount of the liquid phase refrigerant flowing through the flow passage 56l can be increased or decreased. Therefore, the sensors for detecting the temperature and the pressure of the refrigerant and the control by the controller as in the gas-liquid separators 56 and 561 are not necessary for the gas-liquid separator 563. In the following description, the case where the induction member 561b is positioned at the position illustrated in FIG. 11A is referred to as “the induction member 561b is positioned at the closing position”, and the case where the induction member 561b is positioned at the position illustrated in FIG. 11B is referred to as “the induction member 561b is positioned at the opening position”.

Next, effects of the gas-liquid separator 563 in the operation modes of the temperature adjustment system 1 will be described.

First, the case where the temperature of the battery 84 is to be raised (the heating mode) will be described. In this case, the temperature of the refrigerant flowing into the gas-liquid separator 563 is equal to or lower than the predetermined value.

When the temperature of the refrigerant flowing into and stored in the space S is equal to or lower than the predetermined value, as illustrated in FIG. 11B, the induction member 561b moves to the opening position, and the opening degree of the flow passage 56l increases. Accordingly, the liquid phase refrigerant in an amount larger than that in the case where the induction member 561b is positioned at the closing position flows into the flow passage 56l.

The flow passage 56l mixes the liquid phase refrigerant flowing in due to the movement of the induction member 561b with the gas phase refrigerant flowing in from the flow passage 56k. The refrigerant (the gas phase refrigerant and the liquid phase refrigerant) having an increased mixing ratio of the liquid phase refrigerant due to the flow passage 56l is supplied to the electric compressor 52 via the flow passage 56j. In the gas-liquid separator 563, the amount of the liquid phase refrigerant mixed with the gas phase refrigerant is set within a range of an allowable amount of the liquid phase refrigerant that can be received by the electric compressor 52.

In this way, by supplying the refrigerant (the gas phase refrigerant and the liquid phase refrigerant) having an increased mixing ratio of the liquid phase refrigerant to the electric compressor 52, the density of the refrigerant supplied to the electric compressor 52 increases, and the flow rate of the refrigerant supplied from the electric compressor 52 to the water-cooled condenser 53 increases. Accordingly, since the amount of the heat radiated by the water-cooled condenser 53 increases, the performance of heating the cooling water flowing through the cooling water flow passage 83 (the cooling water for exchanging heat with the battery 84) by the water-cooled condenser 53 is improved. Therefore, the battery 84 can be further heated.

Next, the case where the temperature of the battery 84 is to be lowered (the first cooling mode and the second cooling mode) will be described. In this case, the temperature of the refrigerant flowing into the gas-liquid separator 563 is higher than the predetermined value.

When the temperature of the refrigerant flowing into and stored in the space S is higher than the predetermined value, as illustrated in FIG. 11A, the induction member 561b moves to the closing position, and the opening degree of the flow passage 56l decreases. Accordingly, the liquid phase refrigerant in an amount required to lubricate the components of the refrigeration cycle circuit 50 flows into the flow passage 56l only via the through hole 56p.

Therefore, as compared with the case where the temperature of the battery 84 is to be raised, the density of the refrigerant supplied to the electric compressor 52 decreases, and the flow rate of the refrigerant supplied from the electric compressor 52 to the water-cooled condenser 53 also decreases.

When the flow rate of the refrigerant supplied from the electric compressor 52 to the water-cooled condenser 53 decreases, the flow rate of the refrigerant flowing into the variable throttle mechanism 54 also decreases, and the expansion coefficient of the refrigerant in the variable throttle mechanism 54 increases accordingly. Accordingly, the amount of the heat absorbed from the cooling water due to the vaporization of the refrigerant in the chiller 55 is increased, and thus the performance of cooling the cooling water flowing through the cooling water flow passage 83 (the cooling water for exchanging heat with the battery 84) by the chiller 55 is improved. Therefore, the battery 84 can be further cooled.

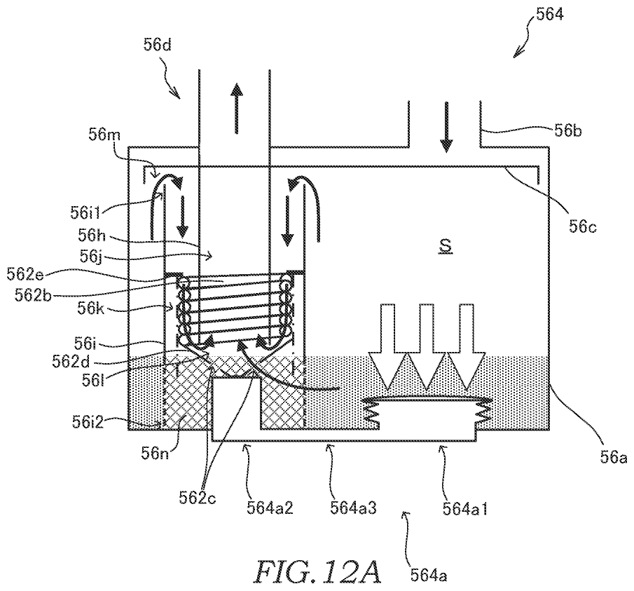

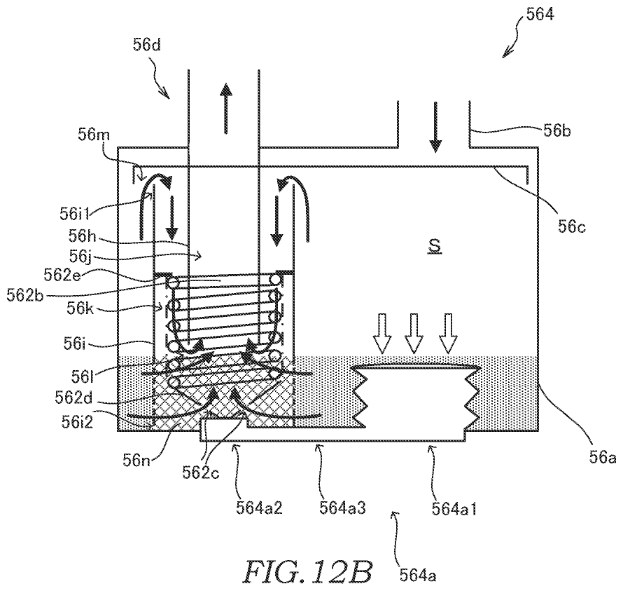

Next, a gas-liquid separator 564 according to the fourth modification will be described with reference to FIGS. 12A and 12B. FIG. 12A is a schematic configuration diagram of the gas-liquid separator 564 in the case where the temperature adjustment system 1 lowers the temperature of the battery 84 (the first cooling mode and the second cooling mode). FIG. 12B is a schematic configuration diagram of the gas-liquid separator 564 in the case where the temperature adjustment system 1 raises the temperature of the battery 84 (the heating mode). In FIGS. 12A and 12B, the same components as those of the gas-liquid separators 56, 561, 562 and 563 are denoted by the same reference numerals, and the description thereof is omitted.

The gas-liquid separator 564 is different from the gas-liquid separators 56, 561, 562 and 563 in that the induction member 562d is moved by the auxiliary spring 562b and an expansion and contraction mechanism 564a that expands and contracts according to a pressure change.

As illustrated in FIGS. 12A and 12B, the gas-liquid separator 564 includes the expansion and contraction mechanism 564a serving as the on-off switching mechanism for increasing or decreasing the flow rate of the liquid phase refrigerant flowing through the flow passage 56l, the auxiliary spring 562b, and the induction member 562d.

The expansion and contraction mechanism 564a includes a first expansion and contraction portion 564a1 that expands and contracts according to the pressure of the refrigerant in the space S, a second expansion and contraction portion 564a2 that expands and contracts according to the expansion and contraction of the first expansion and contraction portion 564a1, and a coupling portion 564a3 that couples the first expansion and contraction portion 564a1 and the second expansion and contraction portion 564a2.

The first expansion and contraction portion 564a1 is a portion where a hollow portion filled with a gas is formed. The first expansion and contraction portion 564a1 is provided at a position outside the outer pipe portion 56i in the tank portion 56a. A pressure receiving portion that receives the pressure of the refrigerant in the space S is formed at one end of the first expansion and contraction portion 564a1. The other end of the first expansion and contraction portion 564a1 is coupled to one end of the coupling portion 564a3.

The second expansion and contraction portion 564a2 is a portion where a hollow portion filled with a gas is formed. The second expansion and contraction portion 564a2 is provided in a manner of being housed in the outer pipe portion 56i on the other end 56i2 side. The induction member 562d is coupled to one end of the second expansion and contraction portion 564a2. Further, a pressure receiving portion that receives the pressure of the refrigerant in the space S is formed at the one end of the second expansion and contraction portion 564a2. The pressure receiving portion of the second expansion and contraction portion 564a2 is formed such that a pressure receiving area is smaller than that of the pressure receiving portion of the first expansion and contraction portion 564a1. The other end of the second expansion and contraction portion 564a2 is coupled to the other end of the coupling portion 564a3.

The coupling portion 564a3 is a portion where a hollow portion through which a gas can flow is formed. The coupling portion 564a3 is provided outside the tank portion 56a such that the pressure of the refrigerant in the space S does not act. The hollow portion of the coupling portion 564a3 communicates with the hollow portion of the first expansion and contraction portion 564a1 by coupling the one end of the coupling portion 564a3 to the other end of the first expansion and contraction portion 564a1. Further, the hollow portion of the coupling portion 564a3 communicates with the hollow portion of the second expansion and contraction portion 564a2 by coupling the other end of the coupling portion 564a3 to the other end of the second expansion and contraction portion 564a2.

That is, the hollow portion of the first expansion and contraction portion 564a1, the hollow portion of the second expansion and contraction portion 564a2, and the hollow portion of the coupling portion 564a3 constitute a continuous hollow portion. The hollow portion is filled with a gas.

As illustrated in FIG. 12A, when the pressure of the refrigerant in the space S is higher than the predetermined value, the first expansion and contraction portion 564a1 provided with the pressure receiving portion having a pressure receiving area larger than that of the pressure receiving portion of the second expansion and contraction portion 564a2 contracts. When the first expansion and contraction portion 564a1 contracts, the gas in the hollow portion of the first expansion and contraction portion 564a1 moves to the hollow portion of the second expansion and contraction portion 564a2 via the hollow portion of the coupling portion 564a3. Accordingly, the second expansion and contraction portion 564a2 expands. Due to the expansion of the second expansion and contraction portion 564a2, the auxiliary spring 562b is contracted and the induction member 562d moves. In this case, the induction member 562d is held at a position where the upper end portion of the induction member 562d is higher than the upper end of the mesh portion 56n. In this case, the liquid phase refrigerant flows into the flow passage 56l only via the through holes 562c.

As illustrated in FIG. 12B, when the pressure of the refrigerant in the space S is equal to or lower than the predetermined value, the first expansion and contraction portion 564a1 expands. The second expansion and contraction portion 564a2 contracts with the expansion of the first expansion and contraction portion 564a1. When the second expansion and contraction portion 564a2 contracts, the induction member 562d moves due to the restoring force of the auxiliary spring 562b. In this case, the induction member 562d is held at a position where the upper end portion of the induction member 562d is higher than the upper end of the mesh portion 56n. In this case, in addition to the through holes 562c, the refrigerant flows into the flow passage 56l also via the mesh portion 56n upper than the upper end portion of the induction member 561b.

That is, in the case where the induction member 562d is positioned at the position in FIG. 12B, the liquid phase refrigerant in an amount larger than that in the case where the induction member 562d is positioned at the position in FIG. 12A can be allowed to flow into the flow passage 56l. In other words, the opening degree of the flow passage 56l in the case where the induction member 562d is positioned at the position illustrated in FIG. 12B is larger than that in the case where the induction member 562d is positioned at the position illustrated in FIG. 12A.

In this way, in the gas-liquid separator 564, the opening degree of the flow passage 56l is automatically changed according to the pressure of the refrigerant in the space S, and the amount of the liquid phase refrigerant flowing in the flow passage 56l can be increased or decreased. Therefore, the sensors for detecting the temperature and the pressure of the refrigerant and the control by the controller as in the gas-liquid separators 56 and 561 are not necessary for the gas-liquid separator 564. In the following description, the case where the induction member 562d is positioned at the position illustrated in FIG. 12A is referred to as “the induction member 562d is positioned at the closing position”, and the case where the induction member 562d is positioned at the position illustrated in FIG. 12B is referred to as “the induction member 562d is positioned at the opening position”.

Next, effects of the gas-liquid separator 564 in the operation modes of the temperature adjustment system 1 will be described.

First, the case where the temperature of the battery 84 is to be raised (the heating mode) will be described. In this case, the pressure of the refrigerant flowing into the gas-liquid separator 564 is equal to or lower than the predetermined value.

When the pressure of the refrigerant flowing into and stored in the space S is equal to or lower than the predetermined value, as illustrated in FIG. 12B, the induction member 562d moves to the opening position, and the opening degree of the flow passage 56l increases. Accordingly, the liquid phase refrigerant in an amount larger than that in the case where the induction member 562d is positioned at the closing position flows into the flow passage 56l.

The flow passage 56l mixes the liquid phase refrigerant flowing in due to the movement of the induction member 562d with the gas phase refrigerant flowing in from the flow passage 56k. The refrigerant (the gas phase refrigerant and the liquid phase refrigerant) having an increased mixing ratio of the liquid phase refrigerant due to the flow passage 56l is supplied to the electric compressor 52 via the flow passage 56j. In the gas-liquid separator 564, the amount of the liquid phase refrigerant mixed with the gas phase refrigerant is set within a range of an allowable amount of the liquid phase refrigerant that can be received by the electric compressor 52.

In this way, by supplying the refrigerant (the gas phase refrigerant and the liquid phase refrigerant) having an increased mixing ratio of the liquid phase refrigerant to the electric compressor 52, the density of the refrigerant supplied to the electric compressor 52 increases, and the flow rate of the refrigerant supplied from the electric compressor 52 to the water-cooled condenser 53 increases. Accordingly, since the amount of the heat radiated by the water-cooled condenser 53 increases, the performance of heating the cooling water flowing through the cooling water flow passage 83 (the cooling water for exchanging heat with the battery 84) by the water-cooled condenser 53 is improved. Therefore, the battery 84 can be further heated.

Next, the case where the temperature of the battery 84 is to be lowered (the first cooling mode and the second cooling mode) will be described. In this case, the pressure of the refrigerant flowing into the gas-liquid separator 564 is higher than the predetermined value.

When the pressure of the refrigerant flowing into and stored in the space S is higher than the predetermined value, as illustrated in FIG. 12A, the induction member 562d moves to the closing position, and the opening degree of the flow passage 56l decreases. Accordingly, the liquid phase refrigerant in an amount required to lubricate the components of the refrigeration cycle circuit 50 flows into the flow passage 56l via the through holes 562c.

Therefore, as compared with the case where the temperature of the battery 84 is to be raised, the density of the refrigerant supplied to the electric compressor 52 decreases, and the flow rate of the refrigerant supplied from the electric compressor 52 to the water-cooled condenser 53 also decreases.

When the flow rate of the refrigerant supplied from the electric compressor 52 to the water-cooled condenser 53 decreases, the flow rate of the refrigerant flowing into the variable throttle mechanism 54 also decreases, and the expansion coefficient of the refrigerant in the variable throttle mechanism 54 increases accordingly. Accordingly, the amount of the heat absorbed from the cooling water due to the vaporization of the refrigerant in the chiller 55 is increased, and thus the performance of cooling the cooling water flowing through the cooling water flow passage 83 (the cooling water for exchanging heat with the battery 84) by the chiller 55 is improved. Therefore, the battery 84 can be further cooled.

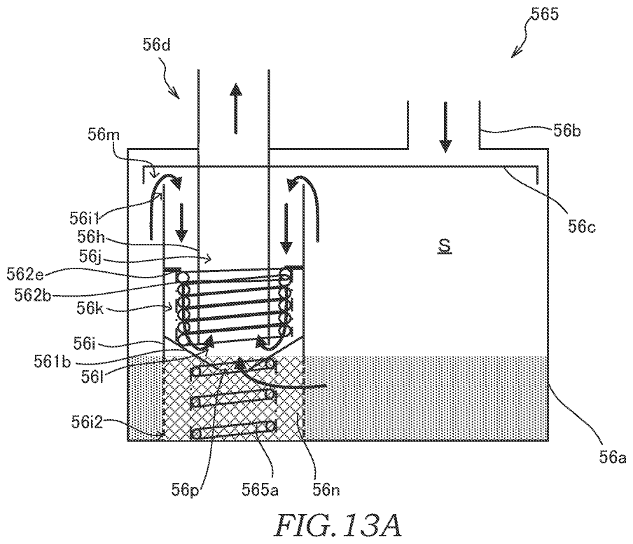

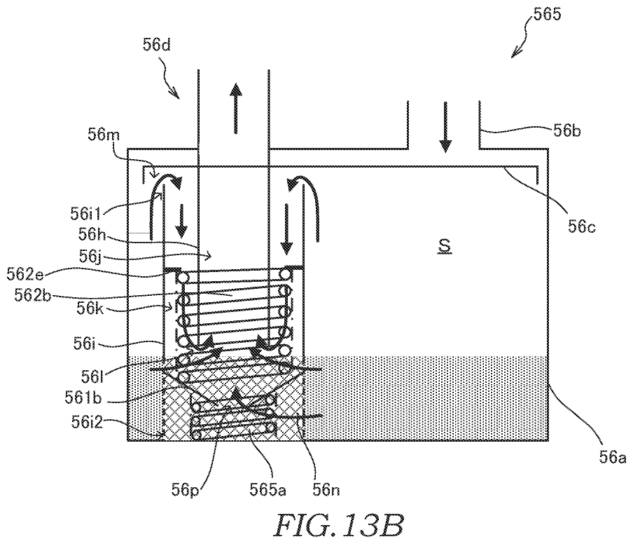

Next, a gas-liquid separator 565 according to the fifth modification will be described with reference to FIGS. 13A and 13B. FIG. 13A is a schematic configuration diagram of the gas-liquid separator 565 in the case where the temperature adjustment system 1 lowers the temperature of the battery 84 (the first cooling mode and the second cooling mode). FIG. 13B is a schematic configuration diagram of the gas-liquid separator 565 in the case where the temperature adjustment system 1 raises the temperature of the battery 84 (the heating mode). In FIGS. 13A and 13B, the same components as those of the gas-liquid separators 56, 561, 562, 563 and 564 are denoted by the same reference numerals, and the description thereof is omitted.

The gas-liquid separator 565 is different from the gas-liquid separators 56, 561, 562, 563 and 564 in that the induction member 561b is moved by a shape memory spring 565a and the auxiliary spring 562b.

As illustrated in FIGS. 13A and 13B, the gas-liquid separator 565 includes the shape memory spring 565a serving as the on-off switching mechanism for increasing or decreasing the flow rate of the liquid phase refrigerant flowing through the flow passage 56l, the auxiliary spring 562b, and the induction member 561b.

In the bottom surface of the tank portion 56a, one end of the shape memory spring 565a is fixed to the position where the other end 56i2 of the outer pipe portion 56i is provided. The other end of the shape memory spring 565a is coupled to a bottom surface side of the induction member 561b. The shape memory spring 565a is housed in the inner periphery of the other end 56i2 of the outer pipe portion 56i.

The shape memory spring 565a is provided in series with the auxiliary spring 562b. The shape memory spring 565a faces the auxiliary spring 562b with the induction member 561b interposed therebetween. When the temperature of the refrigerant in the space S is higher than the predetermined value, the shape memory spring 565a expands as illustrated in FIG. 13A, and when the temperature of the refrigerant in the space S is equal to or lower than the predetermined value, the shape memory spring 565a contracts as illustrated in FIG. 13B.

As illustrated in FIG. 13A, in the case where the shape memory spring 565a expands when the temperature of the refrigerant in the space S is higher than the predetermined value, the auxiliary spring 562b is contracted and the induction member 561b moves. In this case, the induction member 561b is held at a position where the upper end portion thereof is higher than the upper end of the mesh portion 56n. In this case, the liquid phase refrigerant flows into the flow passage 56l only via the through hole 56p.

As illustrated in FIG. 13B, in the case where the shape memory spring 565a contracts when the temperature of the refrigerant in the space S is equal to or lower than the predetermined value, the induction member 561b moves due to the restoring force of the auxiliary spring 562b. In this case, the induction member 561b is held at a position where the upper end portion of the induction member 561b is lower than the upper end of the mesh portion 56n. In this case, in addition to the through holes 562c, the refrigerant flows into the flow passage 56l also via the mesh portion 56n upper than the upper end portion of the induction member 56lb.

That is, in the case where the induction member 561b is positioned at the position in FIG. 13B, the liquid phase refrigerant in an amount larger than that in the case where the induction member 561b is positioned at the position in FIG. 13A can be allowed to flow into the flow passage 56l. In other words, the opening degree of the flow passage 56l in the case where the induction member 561b is positioned at the position illustrated in FIG. 13B is larger than that in the case where the induction member 561b is positioned at the position illustrated in FIG. 13A.

In this way, in the gas-liquid separator 565, the opening degree of the flow passage 56l is automatically changed according to the temperature of the refrigerant in the space S, and the amount of the liquid phase refrigerant flowing in the flow passage 56l can be increased or decreased. Therefore, the sensors for detecting the temperature and the pressure of the refrigerant and the control by the controller as in the gas-liquid separators 56 and 561 are not necessary for the gas-liquid separator 565. In the following description, the case where the induction member 561b is positioned at the position illustrated in FIG. 13A is referred to as “the induction member 561b is positioned at the closing position”, and the case where the induction member 561b is positioned at the position illustrated in FIG. 13B is referred to as “the induction member 56lb is positioned at the opening position”.

Next, effects of the gas-liquid separator 565 in the operation modes of the temperature adjustment system 1 will be described.

First, the case where the temperature of the battery 84 is to be raised (the heating mode) will be described with reference to FIG. 13B. In this case, the temperature of the refrigerant flowing into the gas-liquid separator 565 is equal to or lower than the predetermined value.

When the temperature of the refrigerant flowing into and stored in the space S is equal to or lower than the predetermined value, as illustrated in FIG. 13B, the induction member 561b moves to the opening position, and the opening degree of the flow passage 56l increases. Accordingly, the liquid phase refrigerant in an amount larger than that in the case where the induction member 561b is positioned at the closing position flows into the flow passage 56l.

The flow passage 56l mixes the liquid phase refrigerant flowing in due to the movement of the induction member 561b with the gas phase refrigerant flowing in from the flow passage 56k. The refrigerant (the gas phase refrigerant and the liquid phase refrigerant) having an increased mixing ratio of the liquid phase refrigerant due to the flow passage 56l is supplied to the electric compressor 52 via the flow passage 56j. In the gas-liquid separator 565, the amount of the liquid phase refrigerant mixed with the gas phase refrigerant is set within a range of an allowable amount of the liquid phase refrigerant that can be received by the electric compressor 52.

In this way, by supplying the refrigerant (the gas phase refrigerant and the liquid phase refrigerant) having an increased mixing ratio of the liquid phase refrigerant to the electric compressor 52, the density of the refrigerant supplied to the electric compressor 52 increases, and the flow rate of the refrigerant supplied from the electric compressor 52 to the water-cooled condenser 53 increases. Accordingly, since the amount of the heat radiated by the water-cooled condenser 53 increases, the performance of heating the cooling water flowing through the cooling water flow passage 83 (the cooling water for exchanging heat with the battery 84) by the water-cooled condenser 53 is improved. Therefore, the battery 84 can be further heated.

Next, the case where the temperature of the battery 84 is to be lowered (the first cooling mode and the second cooling mode) will be described. In this case, the temperature of the refrigerant flowing into the gas-liquid separator 565 is higher than the predetermined value.

When the temperature of the refrigerant flowing into and stored in the space S is higher than the predetermined value, as illustrated in FIG. 13A, the induction member 56lb moves to the closing position, and the opening degree of the flow passage 56l decreases. Accordingly, the liquid phase refrigerant in an amount required to lubricate the components of the refrigeration cycle circuit 50 flows into the flow passage 56l only via the through hole 56p.

Therefore, as compared with the case where the temperature of the battery 84 is to be raised, the density of the refrigerant supplied to the electric compressor 52 decreases, and the flow rate of the refrigerant supplied from the electric compressor 52 to the water-cooled condenser 53 also decreases.

When the flow rate of the refrigerant supplied from the electric compressor 52 to the water-cooled condenser 53 decreases, the flow rate of the refrigerant flowing into the variable throttle mechanism 54 also decreases, and the expansion coefficient of the refrigerant in the variable throttle mechanism 54 increases accordingly. Accordingly, the amount of the heat absorbed from the cooling water due to the vaporization of the refrigerant in the chiller 55 is increased, and thus the performance of cooling the cooling water flowing through the cooling water flow passage 83 (the cooling water for exchanging heat with the battery 84) by the chiller 55 is improved. Therefore, the battery 84 can be further cooled.

According to the above embodiment, the following effects are exerted.

The temperature adjustment system 1 for adjusting the temperature of the battery 84 includes: the refrigeration cycle circuit 50 that includes the electric compressor 52 that compresses the refrigerant, the water-cooled condenser 53 that radiates the heat of the refrigerant compressed by the electric compressor 52, the variable throttle mechanism 54 that expands the refrigerant from which the heat is radiated by the water-cooled condenser 53, the chiller 55 that performs the heat exchange by using the refrigerant expanded by the variable throttle mechanism 54, and the gas-liquid separator 56 that performs the gas-liquid separation of the refrigerant used for the heat exchange by the chiller 55 and supplies the gas phase refrigerant to the electric compressor 52; the first cooling water circuit 60 that includes the external heat radiator 64 for radiating the heat of the cooling water to the outside; the second cooling water circuit 70 that heats the cooling water flowing therethrough by the heat of the refrigerant radiated by the water-cooled condenser 53; the third cooling water circuit 80 that cools the cooling water flowing therethrough by the heat exchange with the refrigerant flowing through the chiller 55, and adjusts the temperature of the battery 84 by the heat exchange with the cooling water; the switching valve 91 that connects or disconnects the first cooling water circuit 60 and the second cooling water circuit 70; and the switching valve 92 that connects or disconnects the second cooling water circuit 70 and the third cooling water circuit 80.

In the temperature adjustment system 1, in the first cooling mode for cooling the battery 84, the switching valve 91 connects the first cooling water circuit 60 and the second cooling water circuit 70, and the switching valve 92 disconnects the second cooling water circuit 70 and the third cooling water circuit 80.

According to these configurations, by only switching the switching valve 91 and switching valve 92 each having a simple configuration, the temperature of the battery 84 can be lowered by lowering the temperature of the cooling water flowing through the third cooling water circuit 80 that is subjected to the heat exchange with the battery 84.

Further, in the temperature adjustment system 1, in the heating mode for heating the battery 84, the switching valve 91 disconnects the first cooling water circuit 60 and the second cooling water circuit 70, and the switching valve 92 connects the second cooling water circuit 70 and the third cooling water circuit 80.

According to these configurations, by only switching the switching valve 91 and switching valve 92 each having a simple configuration, the temperature of the battery 84 can be raised by raising the temperature of the cooling water flowing through the third cooling water circuit 80 that is subjected to the heat exchange with the battery 84.

In other words, it is possible to provide the temperature adjustment system 1 capable of adjusting the temperature of the battery 84 with a simple configuration.

The temperature adjustment system 1 further includes the heat pump unit 4 used for the air conditioning in the vehicle interior, and the heat pump unit 4 includes the electric compressor 42 that compresses the air-conditioning refrigerant, the outdoor heat exchanger 44 that radiates the heat of the air-conditioning refrigerant compressed by the electric compressor 42, the variable throttle mechanism 41a that expands the air-conditioning refrigerant from which the heat is radiated by the outdoor heat exchanger 44, and the heat exchanger 49 that performs the heat exchange between the air-conditioning refrigerant expanded by the variable throttle mechanism 41a and the cooling water flowing through the third cooling water circuit 80.

In the temperature adjustment system 1, in the second cooling mode for cooling the battery 84, the switching valve 91 connects the first cooling water circuit 60 and the second cooling water circuit 70, the switching valve 92 disconnects the second cooling water circuit 70 and the third cooling water circuit 80, and the heat exchanger 49 cools the cooling water flowing through the third cooling water circuit 80 by the heat exchange with the air-conditioning refrigerant.

According to these configurations, the cooling water flowing through the third cooling water circuit 80 is cooled by the heat exchange with the refrigeration cycle circuit 50, and is also cooled by the heat exchange with the air-conditioning refrigerant in the heat exchanger 49. Accordingly, the temperature of the battery 84 can be further lowered as compared with the first cooling mode by further lowering the temperature of the cooling water flowing through the third cooling water circuit 80 that is subjected to the heat exchange with the battery 84 as compared with the first cooling mode.

In addition, the third cooling water circuit 80 of the temperature adjustment system 1 includes the bypass flow passage 85 through which the cooling water flows to bypass the battery 84, and the switching valve 86 that switches to flow the cooling water to perform the heat exchange with the battery 84, or to flow the cooling water through the bypass flow passage 85. In the temperature adjustment system 1, in the auxiliary heating mode for assisting the heating in the vehicle interior, the switching valve 91 disconnects the first cooling water circuit 60 and the second cooling water circuit 70, the switching valve 92 connects the second cooling water circuit 70 and the third cooling water circuit 80, the switching valve 86 allows the cooling water to flow through the bypass flow passage 85, and the heat exchanger 49 heats the air-conditioning refrigerant by the heat exchange with the cooling water flowing through the third cooling water circuit 80.

According to this configuration, by heating the air-conditioning refrigerant using the heat generated by the refrigeration cycle circuit 50, it is possible to sufficiently heat the vehicle interior even in the situation where the heating of the vehicle interior cannot be sufficiently performed in the heating mode. Further, in all the modes, the efficiency of the electric compressor 42 can be improved. In addition, the entire system can be simplified.

The gas-liquid separator 56 of the temperature adjustment system 1 includes the flow passage 56e that allows the liquid phase refrigerant to be mixed with the gas phase refrigerant to be supplied to the electric compressor 52, and the variable throttle mechanism 56g that adjusts the opening degree of the flow passage 56e to increase or decrease the flow rate of the liquid phase refrigerant flowing through the flow passage 56e. When the temperature of the battery 84 is to be raised, the opening degree of the flow passage 56e is increased, and when the temperature of the battery 84 is to be lowered, the opening degree of the flow passage 56e is decreased.

According to this configuration, when the temperature of the battery 84 is to be raised, the gas-liquid separator 56 increases the opening degree of the flow passage 56e to increase the flow rate of the refrigerant to be supplied to the electric compressor 52. Accordingly, in the temperature adjustment system 1, the performance of heating the cooling water by the water-cooled condenser 53 can be improved, and the battery 84 can be further heated. Further, when the temperature of the battery 84 is to be lowered, the opening degree of the flow passage 56e is decreased to decrease the flow rate of the refrigerant to be supplied to the electric compressor 52. Accordingly, in the temperature adjustment system 1, the performance of cooling the cooling water by the chiller 55 can be improved, and the battery 84 can be further cooled. The gas-liquid separators 561, 562, 563, 564 and 565 according to the first to fifth modifications also achieve the same effects.

Although the embodiments of the present invention have been described above, the above-mentioned embodiments are merely a part of application examples of the present invention, and do not mean that the technical scope of the present invention is limited to the specific configurations of the above-mentioned embodiments.

The present application claims priority under Japanese Patent Application No. 2020-170649 filed to the Japan Patent Office on Oct. 8, 2020, and an entire content of this application is incorporated herein by reference.

1. A temperature adjustment system configured to adjust a temperature of a device to be subjected to temperature adjustment, the temperature adjustment system comprising:
a refrigeration cycle circuit including a first compressor configured to compress a refrigerant, a heat radiator configured to radiate heat of the refrigerant compressed by the first compressor, a first expansion valve configured to expand the refrigerant from which the heat is radiated by the heat radiator, a chiller configured to perform heat exchange using the refrigerant expanded by the first expansion valve, and a gas-liquid separator configured to perform gas-liquid separation on the refrigerant used for the heat exchange in the chiller and supply a gas phase refrigerant to the first compressor;
a first cooling water circuit including an external heat radiator for radiating heat of cooling water to an outside;
a second cooling water circuit configured to heat the cooling water flowing therethrough by the heat of the refrigerant radiated by the heat radiator;
a third cooling water circuit configured to cool the cooling water flowing therethrough by the heat exchange with the refrigerant flowing through the chiller, and adjust the temperature of the device to be subjected to temperature adjustment by heat exchange with the cooling water;
a first valve configured to connect or disconnect the first cooling water circuit and the second cooling water circuit; and
a second valve configured to connect or disconnect the second cooling water circuit and the third cooling water circuit.

2. The temperature adjustment system according to claim 1, wherein
in a first cooling mode in which the device to be subjected to temperature adjustment is cooled,
the first valve connects the first cooling water circuit and the second cooling water circuit, and
the second valve disconnects the second cooling water circuit and the third cooling water circuit.

3. The temperature adjustment system according to claim 1, wherein
in a heating mode in which the device to be subjected to temperature adjustment is heated,
the first valve disconnects the first cooling water circuit and the second cooling water circuit, and
the second valve connects the second cooling water circuit and the third cooling water circuit.

4. The temperature adjustment system according to claim 1, further comprising:
an air-conditioning refrigeration cycle circuit used for air conditioning in a vehicle interior, the air-conditioning refrigeration cycle circuit including a second compressor configured to compress an air-conditioning refrigerant, an outdoor heat exchanger configured to radiate heat of the air-conditioning refrigerant compressed by the second compressor, a second expansion valve configured to expand the air-conditioning refrigerant from which the heat is radiated by the outdoor heat exchanger, and a heat exchanger configured to perform heat exchange between the air-conditioning refrigerant expanded by the second expansion valve and the cooling water flowing through the third cooling water circuit.

5. The temperature adjustment system according to claim 4, wherein
in a second cooling mode in which the device to be subjected to temperature adjustment is cooled,
the first valve connects the first cooling water circuit and the second cooling water circuit,
the second valve disconnects the second cooling water circuit and the third cooling water circuit, and
the heat exchanger cools the cooling water flowing through the third cooling water circuit by the heat exchange with the air-conditioning refrigerant.

6. The temperature adjustment system according to claim 4, wherein
the third cooling water circuit includes a bypass flow passage through which the cooling water flows to bypass the device to be subjected to temperature adjustment, and a third valve configured to switch to flow the cooling water to perform the heat exchange with the device to be subjected to temperature adjustment, or to flow the cooling water through the bypass flow passage, and
in an auxiliary heating mode for assisting heating of the vehicle interior,
the first valve disconnects the first cooling water circuit and the second cooling water circuit,
the second valve connects the second cooling water circuit and the third cooling water circuit,
the third valve flows the cooling water through the bypass flow passage, and
the heat exchanger heats the air-conditioning refrigerant by the heat exchange with the cooling water flowing through the third cooling water circuit.

7. The temperature adjustment system according to claim 1, wherein
the gas-liquid separator includes a flow passage through which a liquid phase refrigerant is mixed with the gas phase refrigerant supplied to the first compressor, and an on-off switching mechanism configured to adjust an opening degree of the flow passage to increase or decrease a flow rate of the liquid phase refrigerant flowing in the flow passage, and
when the temperature of the device to be subjected to temperature adjustment is to be raised, the opening degree of the flow passage is increased, and when the temperature of the device to be subjected to temperature adjustment is to be lowered, the opening degree of the flow passage is decreased.
